(19) United States
(12) Patent Application Publication
(10) Pub. No.: US 2025/0267756 A1
(43) Pub. Date: Aug. 21, 2025

(54) TRANSMITTING AND RECEIVING A SIGNAL BETWEEN A READER AND A DEVICE

(71) Applicant: Samsung Electronics Co., Ltd., Suwon-si (KR)

(72) Inventors: Jeongho Jeon, San Jose, CA (US); Aristides Papasakellariou, Houston, TX (US)

(21) Appl. No.: 19/044,571

(22) Filed: Feb. 3, 2025

Related U.S. Application Data
(60) Provisional application No. 63/553,868, filed on Feb. 15, 2024.
(60) Provisional application No. 63/644,827, filed on May 9, 2024.

(51) Int. Cl. H04W 76/28; H04L 1/00; H04W 28/06; H04W 56/00

(52) U.S. Cl. CPC H04W 76/28; H04L 1/0061; H04W 28/065; H04W 56/0015

(57) ABSTRACT

Apparatuses and methods for transmitting and receiving a signal between a reader and a device. A method for an Internet of Things (IoT) device to communicate with a reader includes receiving a first signal indicating a start of reader-to-device (R2D) reception, receiving a second signal providing synchronization for the reception of a physical reader-to-device channel (PRDCH), and receiving the PRDCH. The first signal and the second signal are patterns including ON/OFF states in time domain. The PRDCH includes at least one of control information related to R2D reception or device-to-reader (D2R) transmission and a payload providing R2D data. The method further includes determining, based on the reception of the PRDCH, parameters related to D2R transmission including a size of a payload providing D2R data, transmitting a third signal providing synchronization for the reception of a physical device-to-reader channel (PDRCH), and transmitting the PDRCH including the payload providing D2R data.

### CROSS-REFERENCE TO RELATED AND CLAIM OF PRIORITY

The present application claims priority under 35 U.S.C. § 119 (e) to U.S. Provisional Patent Application No. 63/553,868 filed on Feb. 15, 2024 and U.S. Provisional Patent Application No. 63/644,827 filed on May 9, 2024, which are hereby incorporated by reference in their entirety.

### TECHNICAL FIELD

The present disclosure relates generally to wireless communication systems and, more specifically, the present disclosure is related to apparatuses and methods for transmitting and receiving a signal between a reader and a device.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to transmitting and receiving a signal between a reader and a device.

In one embodiment, a method for an Internet of Things (IoT) device to communicate with a reader is provided. The method includes receiving a first signal indicating a start of reader-to-device (R2D) reception, receiving a second signal providing synchronization for the reception of a physical reader-to-device channel (PRDCH), and receiving the PRDCH. The first signal and the second signal are patterns including ON/OFF states in time domain. The first signal has a fixed duration in time. The second signal follows the first signal. The PRDCH includes at least one of control information related to R2D reception or device-to-reader (D2R) transmission and a payload providing R2D data. The control information is provided via layer one (L1) signaling in a separate field or via higher layer signaling as R2D data in the payload. The method further includes determining, based on the reception of the PRDCH, parameters related to D2R transmission including a size of a payload providing D2R data, transmitting a third signal providing synchronization for the reception of a physical device-to-reader channel (PDRCH), and transmitting the PDRCH. The PDRCH includes the payload providing D2R data. The PDRCH follows the third signal.

In another embodiment, an IoT device is provided. The IoT device includes a transceiver configured to receive a first signal indicating a start of R2D reception; receive a second signal providing synchronization for the reception of a PRDCH, and receive the PRDCH. The first signal and the second signal are patterns including ON/OFF states in time domain. The first signal has a fixed duration in time. The second signal follows the first signal. The PRDCH includes at least one of control information related to R2D reception or D2R transmission and a payload providing R2D data. The control information is provided via L1 signaling in a separate field or via higher layer signaling as R2D data in the payload. The IoT device further includes processing circuitry operably coupled with the transceiver. The processing circuitry is configured to determine, based on the reception of the PRDCH, parameters related to D2R transmission including a size of a payload providing D2R data. The transceiver is further configured to transmit a third signal providing synchronization for the reception of a PDRCH and transmit the PDRCH. The PDRCH includes the payload providing D2R data. The PDRCH follows the third signal.

In yet another embodiment, a reader is provided. The reader includes a transceiver configured to transmit a first signal indicating a start of R2D transmission, transmit a second signal providing synchronization for the transmission of a PRDCH, and transmit the PRDCH. The first signal and the second signal are patterns including ON/OFF states in time domain. The first signal has a fixed duration in time. The second signal follows the first signal. The PRDCH includes at least one of control information related to R2D reception or D2R reception and a payload providing R2D data. The control information is provided via L1 signaling in a separate field or via higher layer signaling as R2D data in the payload. The reader further includes a processor operably coupled with the transceiver. The processor is configured to determine, based on the PRDCH, parameters related to D2R reception including a size of a payload providing D2R data. The transceiver is further configured to receive a third signal providing synchronization for the reception of a PDRCH and receive the PDRCH. The PDRCH includes the payload providing D2R data and the PDRCH follows the third signal.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure using orthogonal frequency-division multiplexing (OFDM) according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a DCI format according to embodiments of the present disclosure;

FIGS. 9A and 9B illustrate diagrams of example type-1 backscatter structures for internet of thing(s) (IoT) devices according to embodiments of the present disclosure;

FIG. 10 illustrates a diagram of an example impedance matching circuit according to embodiments of the present disclosure;

FIGS. 11A and 11B illustrate diagrams of example type-2 backscatter structures for internet of thing(s) (IoT) devices according to embodiments of the present disclosure;

FIGS. 12A and 12B illustrate diagrams of example type-2 active structures for internet of thing(s) (IoT) devices according to embodiments of the present disclosure;

FIG. 13 illustrates a timeline for reader-triggered asynchronous system timing synchronization according to embodiments of the present disclosure;

FIG. 14 illustrates a timeline for a reader-triggered locally synchronous system timing synchronization according to embodiments of the present disclosure;

FIG. 15 illustrates a flowchart of an example procedure for receiving a reader-to-device (R2D) signal according to embodiments of the present disclosure;

FIG. 16 illustrates a flowchart of an example procedure for generating a device-to-reader (D2R) signal according to embodiments of the present disclosure;

FIG. 17 illustrates a diagram of an example PRDCH/PDRCH signal architecture according to embodiments of the present disclosure;

FIG. 18 illustrates a flowchart of an example procedure for receiving a R2D signal according to embodiments of the present disclosure;

FIG. 19 illustrates a flowchart of an example procedure for generating and transmitting a D2R signal according to embodiments of the present disclosure;

FIG. 20 illustrates a diagram of an example PRDCH/PDRCH signal architecture according to embodiments of the present disclosure;

FIG. 21 illustrates a diagram of an example R2D/D2R signal architecture according to embodiments of the present disclosure;

FIG. 22 illustrates a flowchart of an example procedure for receiving a R2D signal according to embodiments of the present disclosure;

FIG. 23 illustrates a diagram of an example device 1 structure for IoT devices according to embodiments of the present disclosure;

FIG. 24 illustrates a diagram of an example device 2a structure for IoT devices according to embodiments of the present disclosure;

FIG. 25 illustrates a diagram of an example device 2a structure for IoT devices according to embodiments of the present disclosure;

FIG. 26 illustrates a diagram of an example device 2a structure for IoT devices according to embodiments of the present disclosure;

FIG. 27 illustrates a diagram of an example device 2b structure for IoT devices according to embodiments of the present disclosure;

FIG. 28 illustrates a diagram of an example device 2b structure for IoT devices according to embodiments of the present disclosure;

FIG. 29 illustrates a diagram of an example device 2b structure for IoT devices according to embodiments of the present disclosure;

FIG. 30 illustrates an example system for device to receiver (D2R)/reader to device (R2D) transmission including an intermediate node according to embodiments of the present disclosure;

FIG. 31 illustrates a flowchart of an example procedure for receiving a reader to device (R2D) preamble according to embodiments of the present disclosure;

FIG. 32 illustrates a flowchart of an example procedure for generating a device to reader (D2R) preamble according to embodiments of the present disclosure;

FIG. 33 illustrates a diagram of an example physical reader to device (R2D) channel (PRDCH)/physical device to reader (D2R) channel (PDRCH) signal structure according to embodiments of the present disclosure;

FIG. 34 illustrates a flowchart of an example procedure for receiving a R2D midamble according to embodiments of the present disclosure;

FIG. 35 illustrates a flowchart of an example procedure for generating a D2R midamble according to embodiments of the present disclosure; and

FIG. 36 illustrates a diagram of an example PRDCH/PDRCH signal structure with midamble according to embodiments of the present disclosure.

### DETAILED DESCRIPTION

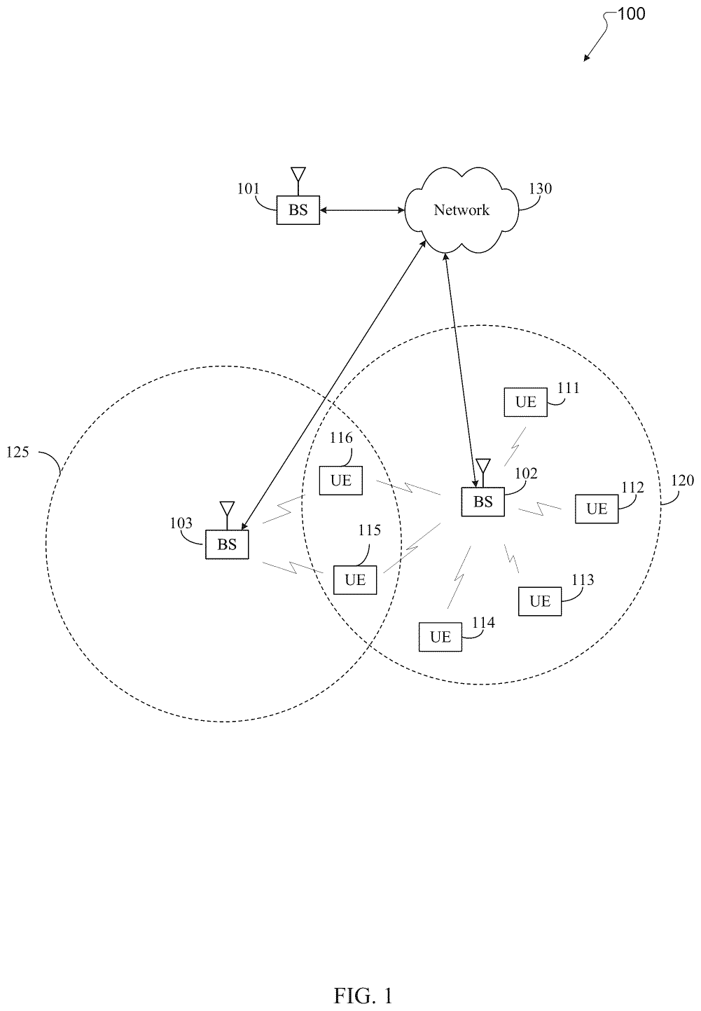

FIGS. 1-36, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF1] 3GPP TS 38.211 v17.6.0, “NR; Physical channels and modulation;” [REF2] 3GPP TS 38.212 v17.6.0, “NR; Multiplexing and channel coding;” [REF3] 3GPP TS 38.213 v17.6.0, “NR; Physical layer procedures for control;” [REF4] 3GPP TS 38.214 v17.6.0, “NR; Physical layer procedures for data;” [REF5] 3GPP TS 38.331 v17.5.0, “NR; Radio Resource Control (RRC) protocol specification;” and [REF6] 3GPP TS 38.321 v17.5.0, “NR; Medium Access Control (MAC) protocol specification.”

FIGS. 1-3 below describe various embodiments implemented in wireless communications systems and with the use of orthogonal frequency-division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for transmitting and receiving a signal between a reader and a device (for example, the UE acting an IoT device). In certain embodiments, one or more of the gNBs 101-103 include circuitry, programing, or a combination thereof to provide for transmitting and receiving a signal between a reader (for example, gNB acting as a reader) and a device.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

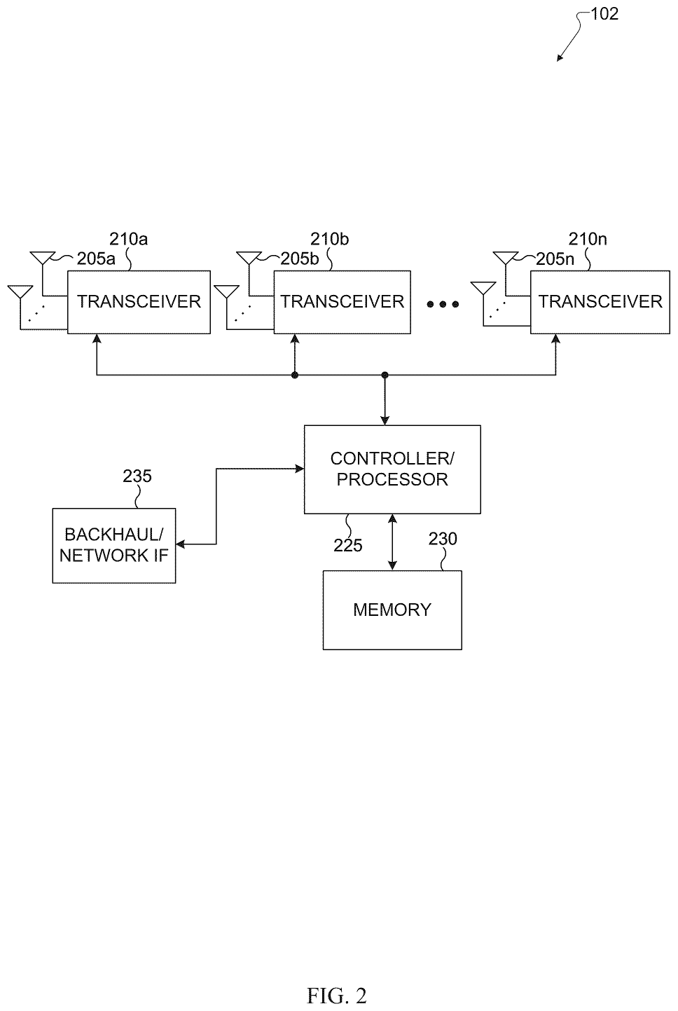

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as providing for transmitting and receiving a signal between a reader and a device. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

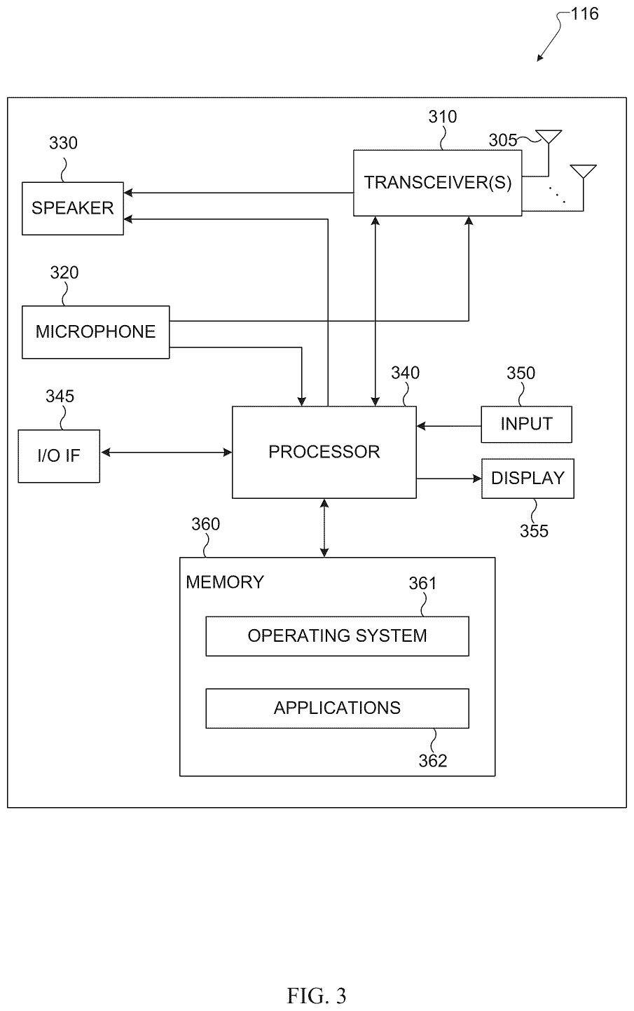

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for transmitting and receiving a signal between a reader and a device as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

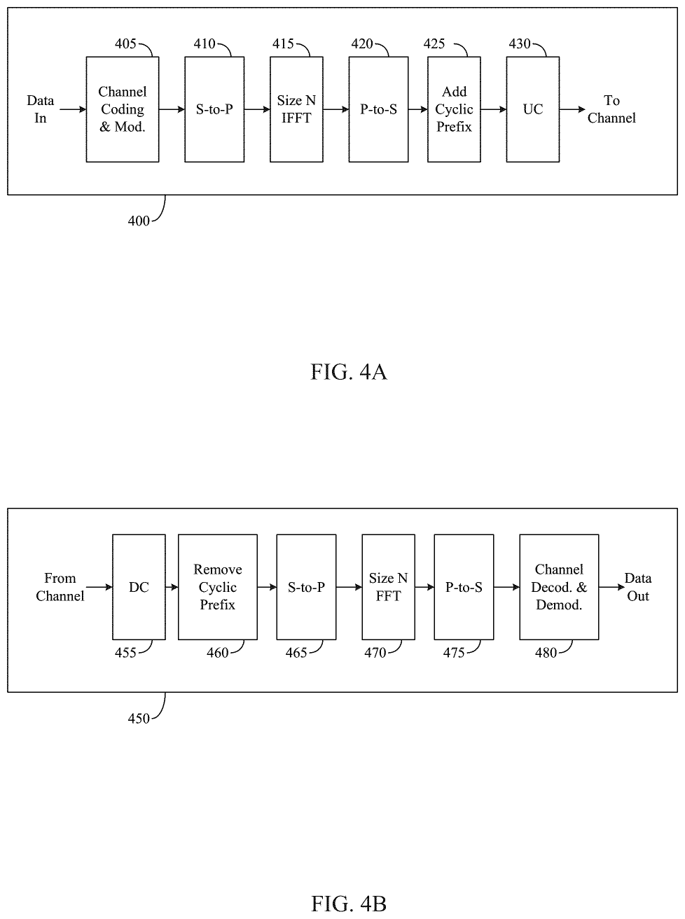

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 may perform transmitting and receiving a signal between a reader and a device as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Internet of things (IoT) devices include ambient-power-enabled IoT (A-IoT) devices, which are ultra-low-complexity devices with very small form factor and low-cost design that operate without a common battery that can be manually replaced or recharged. Instead, A-IoT devices can be battery-less or with a small battery (such as a small capacitor) that operate based on energy harvesting from RF waveforms or other ambient energy sources. Regarding the limited size and complexity required by practical applications for battery-less devices with no energy storage capability or devices with limited energy storage that do not need to be replaced or recharged manually, the output power of energy harvester is typically from 1 μW to a few hundreds of μW.

In various embodiments throughout the disclosure, a UE or a device may be referred to as an A-IoT device or an A-IoT UE based on energy harvesting with ultra-low complexity and power consumption and for low-end IoT applications. For example, the UE may have limited (or no) energy storage or battery capability (e.g., a capacitor), such as an energy storage unit for amplification of receptions at the UE or transmission by the UE, or for other UE operations, such as power-on, warm-up, memory, internal processing, and so on, or operating with backscattering communication.

An A-IoT device can be an IoT device that satisfies one or more of the following (or variations thereof):
powered by energy harvesting, being either battery-less or with limited energy storage capability (e.g., using a capacitor) and the energy is provided through the harvesting of radio waves (including RF waveforms), light (including solar light or indoor light), motion, pressure, heat, or any other power source that could be seen suitable;
with low complexity, small size and lower capabilities and lower power consumption than previously defined 3GPP IoT devices (e.g., NB-IoT/enhanced machine type communication (eMTC) devices);
1 maintenance free and can have long life span (e.g., more than 10 years).

An A-IT may directly communicate with a base station/gNB (e.g., operating as a reader), or may indirectly communicate with a base station/gNB through an intermediate/assisting node, such as a handheld device/UE (for example, a “reader” UE that scans the A-IoT devices), a relay, integrated access and backhaul (IAB) node, a repeater for example a network-controlled repeater (NCR), and so on. The communication can be mono-static wherein the transmitter node to the A-IoT UE is same as the receiving node from the A-IoT UE, or can be bi-static (or multi-static) wherein the transmitter nodes to the A-IoT UE can be different from the receiving nodes from the A-IoT UE.

In various embodiments, the A-IoT device operates with energy storage and power management capability. These devices are characterized by ultra-low power consumption, and they employ energy harvesting mechanisms such as solar, RF energy and kinetic energy and thus don't require battery replacement or swapping frequently. In various embodiments, an A-IoT device operates with energy harvesting (EH) or with limited (or no) energy storage/battery capability (such as a capacitor), such as an energy storage unit for amplification of receptions at the UE or transmission by the UE, or for other UE operations, such as power-on, warm-up, memory, internal processing, and so on, or operating with backscattering communication.

In various embodiments, the A-IoT device operates with RF envelope detection for receiving amplitude shift keying (ASK), e.g., OOK, modulated signal. RF envelope detection is a key function that enables the Ambient IoT devices to filter and analyze RF signals. This technique is applied in the reception of modulated RF signals with a view of acquiring information from the signals and hence enable communication between devices with efficiency and with minimum power consumption. RF envelope detection is one of the most important techniques that are used in many of the low power consumption wireless communication protocols that are employed in Ambient IoT systems.

In various embodiments, the A-IoT device may operate with impedance matching. Impedance matching may be utilized in passive Ambient IoT devices backscattering externally provisioned CW signal.

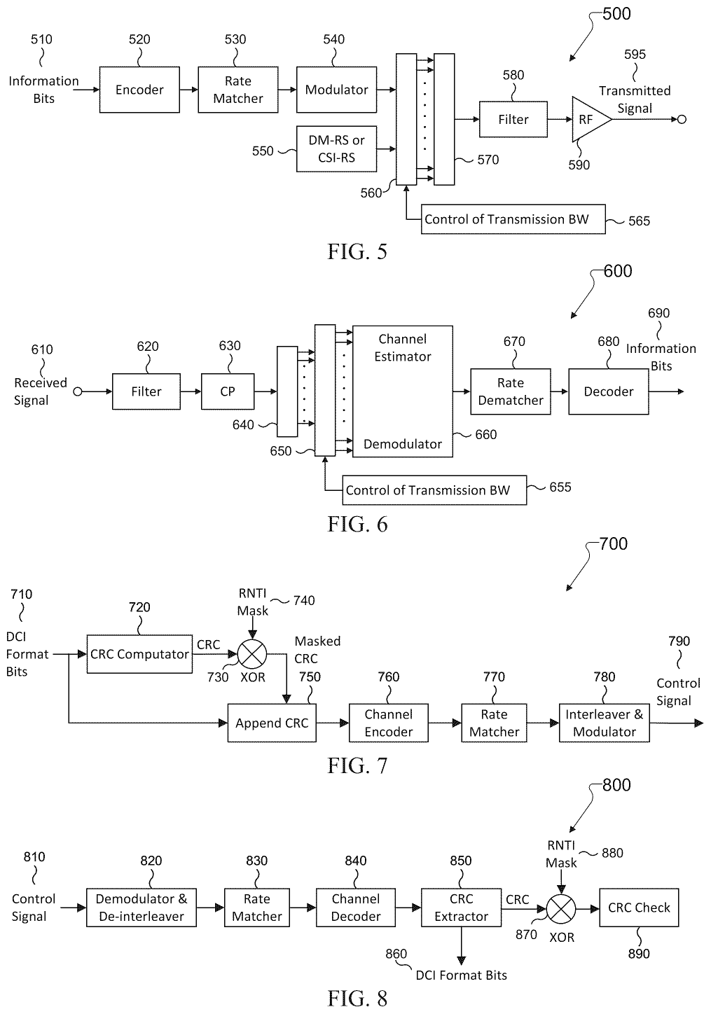

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and demodulation reference signal (DM-RS) or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

FIG. 6 illustrates an example of a receiver structure 600 using OFDM according to embodiments of the present disclosure. For example, receiver structure 600 using OFDM can be implemented by any of the UEs 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

FIG. 7 illustrates an example encoding structure 700 for a downlink control information (DCI) format according to embodiments of the present disclosure. For example, can be implemented in gNB 102 of FIG. 1. This example is for illustration only and other embodiments can be used without departing from the scope of the present disclosure.

A gNB (e.g., the BS 102) separately encodes and transmits each DCI format in a respective physical downlink control channel (PDCCH). When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR(0,0)=0, XOR(0,1)=1, XOR(1,0)=1, XOR(1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

DCI can serve several purposes. A DCI format includes a number of fields, or information elements (IEs), and is typically used for scheduling a physical downlink shared channel (PDSCH) (DL DCI format) or a physical uplink shared channel (PUSCH) (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a PDSCH or a PUSCH for a single UE with RRC connection to a gNB, the RNTI is a cell RNTI (C-RNTI) or another RNTI type such as a modulation and coding scheme-cell RNTI (MCS-C-RNTI). For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a TPC-RNTI, and so on. Each RNTI type is configured to a UE through higher layer signaling. A UE typically decodes at multiple candidate locations for PDCCH receptions as determined by an associated search space set.

With reference to FIG. 7, an example encoding process for a DCI format according to this disclosure is shown.

With reference to FIG. 8, an example decoding process for a DCI format for use with a UE according to this disclosure is shown.

It is envisaged that the number of connected devices will reach ˜500 billion by 2030, which is about ˜59 times larger than the expected world population (˜8.5 billion) by that time. Mobile devices will take various form-factors, such as augmented reality (AR) glasses, virtual reality (VR) headsets, hologram devices, while a large portion of the devices will be Internet-of-Things (IoT) devices for improving productivity efficiency and increasing comforts of life. As the number of IoT devices grows exponentially, those IoT devices will become dominant in the next generation wireless communication systems such as fifth generation (5G) advanced, sixth generation (6G) systems, and so on.

With the explosive number of IoT devices, it may be challenging to power the IoT devices by battery that needs to be replaced or recharged manually, which leads to high maintenance cost. The automation and digitalization of various industries demand new IoT technologies of supporting batteryless devices with no energy storage capability or devices with energy storage that does not need to be replaced or recharged manually. Such types of devices are collectively termed as ambient IoT (A-IoT) in this disclosure, which is powered by various renewable energy sources such as radio waves, light, motion, or heat, etc. Use cases of A-IoT devices include asset inventory/tracking and remote environmental monitoring. The following list provides example use cases of A-IoT devices:
Indoor inventory
   Automated warehousing
   Medical instruments inventory management and positioning
   Non-Public Network for logistics
   Automobile manufacturing
   Airport terminal/shipping port
   Smart laundry
   Automated supply chain distribution
   Fresh food supply chain
   End-to-end logistics
   Flower auction
   Electronic shelf label
Indoor sensor
   Smart homes
   Base station machine room environmental supervision
   Smart laundry
   Smart agriculture
   Smart pig farm
   Cow stable
Indoor positioning
   Finding Remote Lost Item
   Location service
   Ranging in a home
   Personal belongings finding
   Positioning in shopping center
   Museum Guide
Indoor command
   Online modification of medical instruments status
   Device activation and deactivation
   Elderly Health Care
   Device Permanent Deactivation
   Electronic shelf label
Outdoor inventory
   Medical instruments inventory management and positioning
   Non-public network for logistics
   Airport terminal/shipping port
   Automated supply chain distribution
Outdoor sensor
   Smart grids
   Forest Fire Monitoring
   Dairy farming
   Smart manhole cover safety monitoring
   Smart bridge health monitoring
Outdoor positioning
   Finding remote lost item
   Location service
   Personal belongings finding
Outdoor command
   Online modification of medical instruments status
   Device activation and deactivation
   Elderly Health Care
   Controller in smart agriculture

Evaluating the limited size and low complexity required by practical applications of A-IoT devices, the output power of energy harvesting from ambient power sources is typically from 1 μW to a few hundreds of μW, which is orders of magnitude lower than normal user equipment (UE) having peak power consumption higher than 10 mW. This requires a new wireless access technology for A-IoT devices, which cannot be fulfilled by existing cellular systems including low-power IoT technologies such as NB-IoT and eMTC.

Wireless communication has been one of the most successful innovations in modern history. Recently, the number of subscribers to wireless communication services exceeded five billion and continues to grow quickly as predicted herein. The demand of wireless data traffic is rapidly increasing due to the growing popularity among consumers and businesses of smart phones and other mobile data devices, such as tablets, “note pad” computers, net books, eBook readers, and machine type of devices including A-IoT devices. In order to meet the high growth in mobile data traffic and support new applications, deployments, and device types, improvements in radio interface efficiency and coverage is of paramount importance. In 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. The technological evolution will be continued in the next generation 6G systems.

In the following, an italicized name for a parameter implies that the parameter is provided by higher layers.

DL transmissions or UL transmissions can be based on an OFDM waveform including a variant using DFT precoding that is known as DFT-spread-OFDM that is typically applicable to UL transmissions.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments consider a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}. 15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in 3GPP TS 36.211 [REF1] v17.6.0, “NR; Physical channels and modulation”, and 3GPP TS 38.213 [REF3] v17.6.0 “NR; Physical Layer procedures for control”.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element to resource element group (CCE-to-REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates MS-per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in TS 38.212 [REF2] v17.6.0, or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ)mod kₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots. The UE determines CCEs for monitoring PDCCH according to a search space set based on a search space equation as described in TS 38.213 [REF3] v17.6.0.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE monitors PDCCH, the UE aligns the size of some DCI formats, as described in TS 38.212 [REF2] v17.6.0, so that the DCI size limit would not be exceeded.

For each scheduled cell, the UE is not required to monitor on the active DL BWP with SCS configuration μ of the scheduling cell more than min(M_{PDCCH}^{max,slot,μ}, M_{PDCCH}^{total,slot,μ}) PDCCH candidates or more than min(C_{PDCCH}^{max,slot,μ}, C_{PDCCH}^{total,slot,μ}) non-overlapped CCEs per slot, wherein M_{PDCCH}^{max,slot,μ} and C_{PDCCH}^{max,slot,μ} are respectively a maximum number of PDCCH candidates and non-overlapping CCEs for a scheduled cell and M_{PDCCH}^{total,slot,μ} and C_{PDCCH}^{total,slot,μ} are respectively a total number of PDCCH candidates and non-overlapping CCEs for a scheduling cell, as described in TS 38.213 [REF3] v17.6.0.

A UE does not expect to be configured CSS sets, other than CSS sets for multicast PDSCH scheduling, that result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the limits/maximum per slot for scheduling on the primary cell mentioned herein, the UE selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in TS 38.213 [REF3] v17.6.0.

For same cell scheduling or for cross-carrier scheduling where a scheduling cell and scheduled cells have DL BWPs with same SCS configuration u, a UE does not expect a number of PDCCH candidates, and a number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in TS 38.213 [REF3] v17.6.0 and TS 38.214 [REF4] v17.6.0.

MIMO technologies have a key role in boosting system throughput both in NR and LTE and such a role will continue and further expand in the future generations of wireless technologies. For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

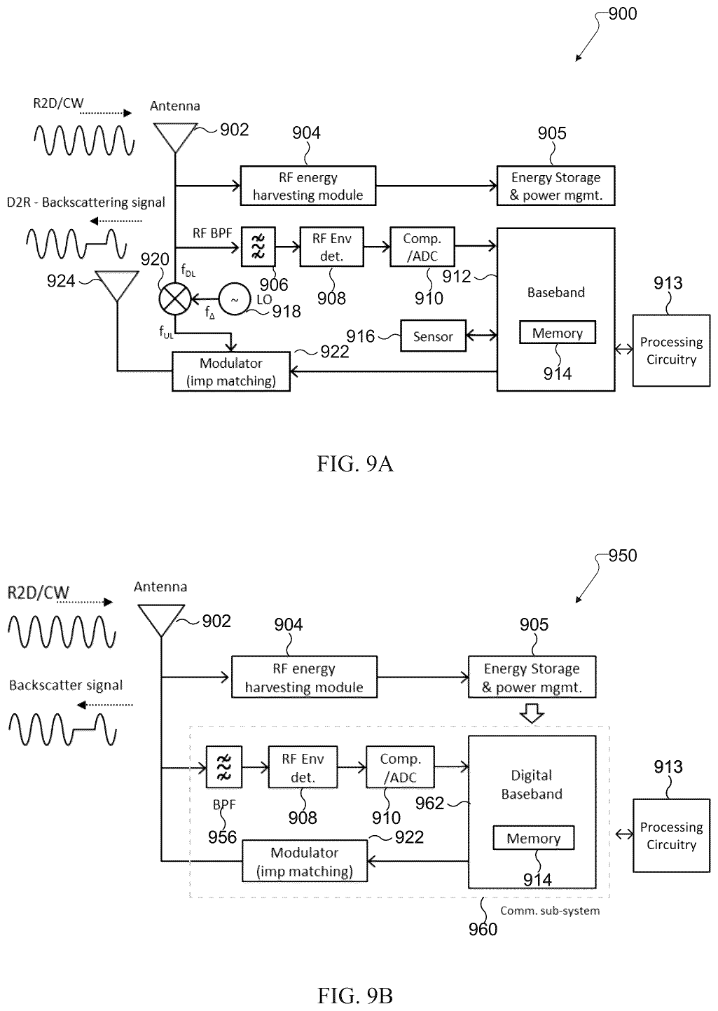

FIGS. 9A and 9B illustrate diagrams of example type-1 backscatter structures 900 and 950 for internet of thing(s) (IoT) devices according to embodiments of the present disclosure. For example, backscatter structures 900 and 950 can be implemented by a UE, such as UE 116 of FIG. 3, or may be devices with fewer components and functionality that a UE. This example is for illustration only and other embodiments can be used without departing from the scope of the present disclosure.

As shown in FIG. 9A, the type-1 backscatter structure 900 includes an antenna 902, a RF energy harvesting module 904, an energy storage and power management 905, a RF BPF 906, a RF envelope detector 908, a comparator/analog to digital converter (ADC) 910, a baseband 912, a memory 914, processing circuitry 913, a sensor 916, a local oscillator (LO) 918, a mixer 920, a modulator (impedance matching) 922, and an antenna 924.

As shown in FIG. 9B, the type-1 backscatter structure 950 includes an antenna 902, a RF energy harvesting module 904, an energy storage and power management 905, processing circuitry 913, and a communication sub-system 960. The communication sub-system 960 includes a BPF 956, a RF envelope detector 908, a comparator/ADC 910, a digital baseband 962, a memory 914, and a modulator (impedance matching) 922.

In various embodiments, the processing circuitry 913, which may be a full-powered processor, such as included in UE 116, a lower-power microprocessor or microcontroller, an application specific integrated circuit (ASIC), or logic circuitry. The processing circuitry 913 can control the overall operation of the IoT device including determination of reception and/or transmission timing. The processing circuitry 913 may be powered via energy storage and power management 905. The signal receiving and transmitting processing circuitry included in the IoT devices, such as RF BPF 906, a RF envelope detector 908, a comparator/analog to digital converter (ADC) 910, a baseband 912, a LO 918, a mixer 920, a modulator (impedance matching) 922, may be referred to as a transceiver, which may use separate antennas 902 and 924 for reception and transmission, respectively, or may use a common antenna, such as antenna 902 for transmission and reception. One or more implementations described herein further include other implementation variations such as separate Tx-Rx antennas vs common Tx-Rx antenna, use of a sensor, etc. The implementations should be understood as an example and not as a restriction.

Several different types of A-IoT devices can be evaluated. One device type has ˜1 μW peak power consumption, energy storage, initial sampling frequency offset (SFO) up to 10^{X} ppm, neither DL (e.g., R2D) nor UL (e.g., D2R) amplification in the device, wherein the device's D2R transmission is backscattered on a carrier wave (CW) provided externally. This type of device is referred to as Type-1 backscatter device, or Type-1 device in short, in this disclosure. Another type of device has ≤ a few hundred μW peak power consumption, energy storage, initial sampling frequency offset (SFO) up to 104 ppm, both R2D and/or D2R amplification in the device, wherein the device's D2R transmission may be generated internally by the device, or be backscattered on a CW provided externally, which are referred to as Type-2 active device and Type-2 backscatter device, respectively.

FIGS. 9A and 9B illustrates example Type-1 backscatter device structures.

The RF energy harvesting can be a viable solution for supplying power to a Type-1 backscatter device requiring ˜1 μW peak power consumption. Either a R2D signal or an externally provisioned CW signal for backscattering can be utilized for RF energy harvesting. The CW is externally provided from a gNB or a dedicated source. The source of CW signal, e.g., either a gNB or a dedicated node, shall be agnostic to A-IoT devices. The harvested energy, e.g., using a rectifier, can be stored using a capacitor, super-capacitor, or, generally speaking, an energy storage.

The R2D signal is demodulated using a low complexity envelop detector and comparator, whose output is provided as an input to the baseband circuit. Given the low-power and low-complexity requirements of the Type-1 backscatter device, an RF envelop detection can be a viable solution for a receiver architecture, compared to a heterodyne architecture with IF envelope detection or a homodyne architecture with baseband envelope detection, which require LO and frequency mixer for frequency down-conversion. The input RF signal passes through an RF band-pass filter (BPF), in the case of implementation B, for an adjacent channel interference suppression, and then the filtered RF signal is directly converted into a digital signal using an RF envelop detector and an n-bit comparator, depending on the modulation scheme.

For the D2R backscatter transmission, the following cases can be evaluated:
Case 1) CW is provisioned at DL spectrum and backscattered, i.e., CW @ DL spectrum, D2R backscattering @ DL spectrum.
Case 2) CW is provisioned at UL spectrum and backscattered, i.e., CW @ UL spectrum, D2R backscattering @ UL spectrum.
Case 3) CW is provisioned at DL spectrum, frequency shifted to UL spectrum, and then backscattered, i.e., CW @ DL spectrum, D2R backscattering @ UL spectrum.

The TDD spectrum case can be evaluated similarly as one of the Case 1) or Case 2), i.e., CW and D2R backscattering on the same frequency. The Case 3) for frequency division duplexing (FDD) spectrum requires a frequency shifter due to a duplex spacing which requires LO and frequency mixer. The duplex spacing of FDD spectrum ranges from at least 10 MHz to a few hundred MHz depending on the carrier frequency.

The implementation A expects Case 3), i.e., the D2R signal transmission is via backscattering of the externally provided CW involving a frequency shifter, if the CW is provided in a frequency different than the D2R carrier frequency. Type-1 backscatter can also operate in a TDD spectrum. In this case, the device does not require a frequency shifter to obtain a desired frequency shifting. Taking into account that the A-IoT devices are targeting for low complexity and low power consumption, the following options can be evaluated as an example method for frequency shift:
Ultra-low power local oscillator (LO), whose output frequency is multiplied in one or more stages using a frequency multiplier to obtain a desired amount of frequency shift.
Calibrated RC (resistor-capacitor) oscillator, which uses CW frequency as an input to the RC oscillator with phase locked loop (PLL) circuitry.
CW signal provided at the D2R carrier frequency; In this case, no frequency shifter is needed.
Use of harmonic frequencies of CW signal or intermodulation frequencies of two-tone CW signals.

The implementation B expects either Case 1) or Case 2), which does not require a frequency shifter.

The implementation A and B further include other implementation variations such as separate Tx-Rx antennas vs common Tx-Rx antenna, use of a sensor, etc. The implementations should be understood as an example and not as a restriction.

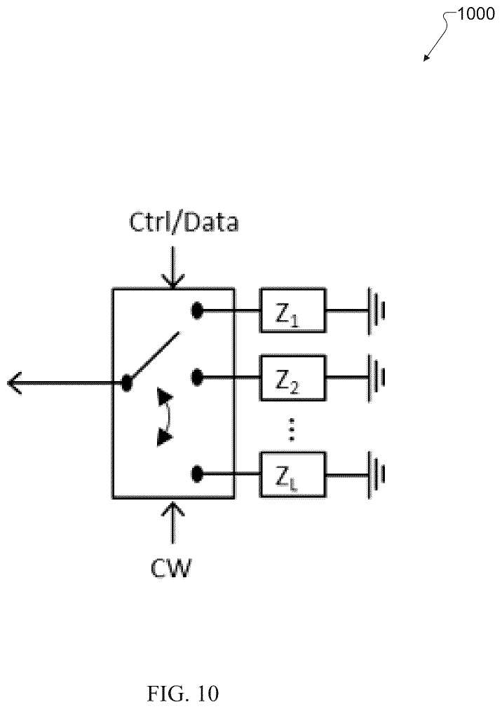

FIG. 10 illustrates a diagram of an example impedance matching circuit 1000 according to embodiments of the present disclosure. For example, impedance matching circuit 1000 can be implemented in the modulator (impedance matching) 922 of an IoT device. This example is for illustration only and other embodiments can be used without departing from the scope of the present disclosure.

FIG. 10 illustrates an example impedance matching circuit for backscatter device D2R modulation.

The followings are simple examples of impedance matching operations:
Open circuit: Full reflection of the received CW signal in the same phase. This can be used for on-off keying (OOK) modulation with matching circuit.
Short circuit: Full reflection of the received CW signal in the reversed phase. This can be used for phase-shift keying (PSK) modulation.
Matching circuit: No reflection as the impedance is matched to a load, i.e., absorption. This can be utilized for energy harvesting, Rx mode, or modulation with other matching states.
Multi-level matching circuit: As illustrated in FIG. 10. Multi-level impedance matching to Z₁, Z₂, . . . , Z_{L} for log₂(L) bits per symbol ASK modulation.

Depending on the matched load impedance, the matching circuit can backscatter the incoming CW signal with different reflection coefficients in both amplitude and phase. In general, ASK/PSK/frequency shift keying (FSK) may be supported using an impedance matching circuit. As a simplest modulation scheme, OOK may be evaluated for A-IoT, given its low complexity. The UE may indicate its modulation capability or impedance matching capability to the network (e.g., the network 130), or certain requirement may be predefined in the specification of system operation.

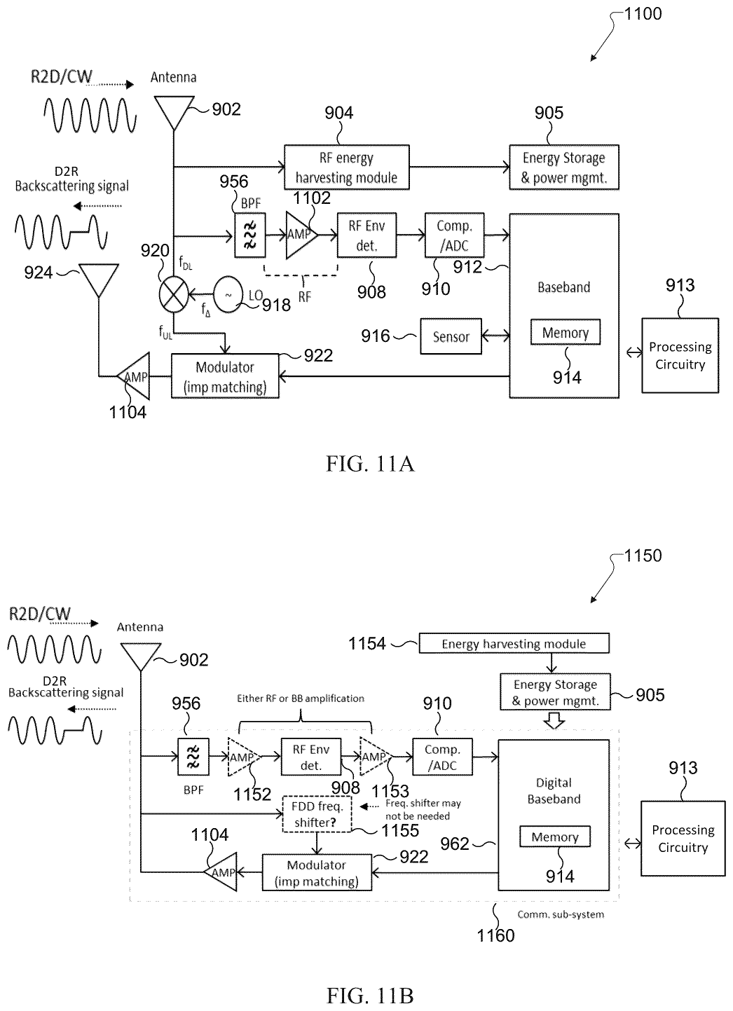

FIGS. 11A and 11B illustrate diagrams of example type-2 backscatter structures 1100 and 1150 for internet of thing(s) (IoT) devices according to embodiments of the present disclosure. For example, type-2 backscatter structures 1100 and 1150 can be implemented by a UE, such as UE 116 of FIG. 3, or may be devices with fewer components and functionality than a UE. This example is for illustration only and other embodiments can be used without departing from the scope of the present disclosure.

As shown in FIG. 11A, the type-2 backscatter structure 1100 includes an antenna 902, a RF energy harvesting module 904, an energy storage and power management 905, a bandpass filter (BPF) 956, an amplifier 1102, a RF envelope detector 908, a comparator/ADC 910, a baseband 912, a memory 914, processing circuitry 913, a sensor 916, a LO 918, a mixer 920, a modulator (impedance matching) 922, an amplifier 1104, and an antenna 924.

As shown in 11B, the type-2 backscatter structure 1150 includes an antenna 902, an energy harvesting module 1154, an energy storage and power management 905, a BPF 956, an amplifier 1152, a RF envelope detector 908, an amplifier 1153, a comparator/ADC 910, a digital baseband 962, a memory 914, processing circuitry 913, a FDD frequency shifter 1155 a modulator (impedance matching) 922, and an amplifier 1104.

FIGS. 11A and 11B illustrates example Type-2 backscatter device structures.

The Type-2 backscatter device may share similar structure at large with the Type-1 device as the D2R transmission is still based on backscattering of an externally provided CW, while the Type-2 backscatter device may differ from Type-1 device from the following aspects.

The Type-2 device has ≤ a few hundred μW peak power consumption and both R2D and/or D2R amplification in the device. In this case, alternative to the RF energy harvesting from a R2D signal or an externally provided CW signal as illustrated in the implementation A, other renewable energy sources, e.g., solar, thermal, kinetic, etc., may be evaluated for energy harvesting, as illustrated in the implementation B. The presence of a certain energy harvesting capability from a certain renewable energy source may be assumed for system design point of view.

The Type-2 devices may be equipped with both R2D and/or D2R amplification in the device. Given the power consumption requirement, i.e., ≤ a few hundred μW, the R2D/D2R amplification for Type-2 devices may be based on an architecture that is different from the common power amplifier (PA) and low noise amplifier (LNA) based on MOSFET. In some example low-power/complexity forward amplification (for R2D reception) and reflection amplification (for D2R backscattering) architectures, a single bipolar transistor terminated with microstrips may be used. The R2D amplification can be either RF amplification prior to the envelop detector, as illustrated in the implementation A, or baseband amplification prior to the comparator/ADC as illustrated in the implementation B, which is an implementational choice.

One additional difference of Type-2 devices compared to Type-1 devices may be a use of FDD frequency shifter. With a few hundred W peak power consumption, some low-power LO architectures with a frequency mixer can be envisioned for Case 3).

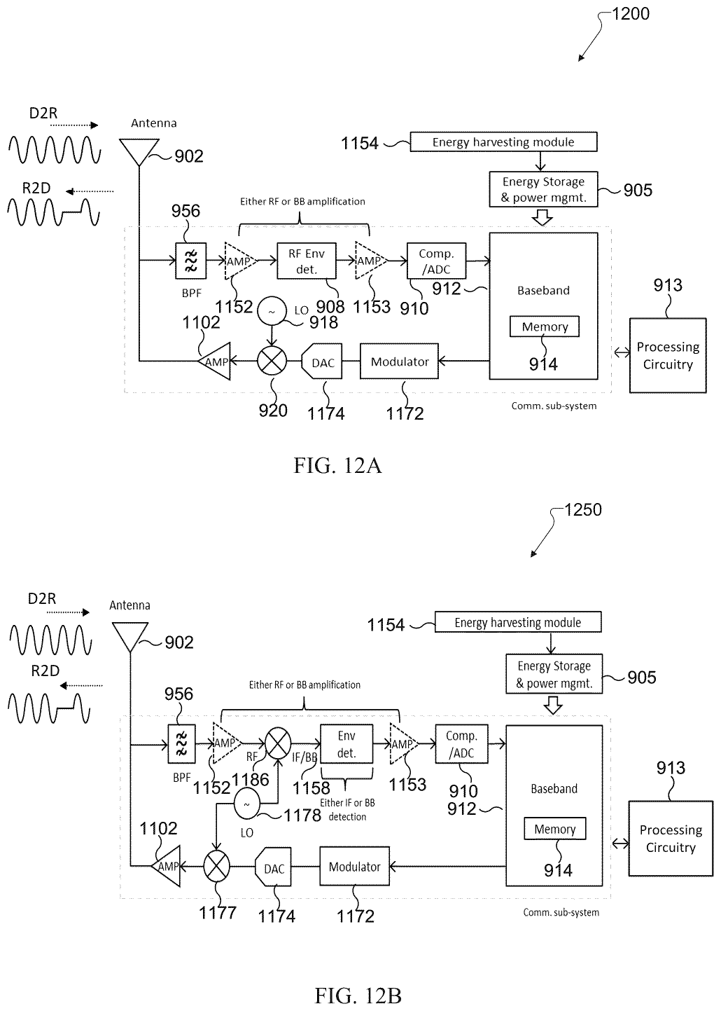

FIGS. 12A and 12B illustrate diagrams of example type-2 active structures 1200 and 1250 for internet of thing(s) (IoT) devices according to embodiments of the present disclosure. For example, type-2 backscatter active structures 1200 and 1250 can be implemented by a UE, such as UE 116 of FIG. 3, or may be devices with fewer components and functionality than a UE. This example is for illustration only and other embodiments can be used without departing from the scope of the present disclosure.

As shown in FIG. 12A, type-2 active structure 1200 includes an antenna 902, an energy harvesting module 1154, an energy storage and power management 905, a BPF 956, an amplifier 1152, a RF envelope detector 908, an amplifier 1153, a comparator/ADC 910, a baseband 912, a memory 914, processing circuitry 913, a modulator 1172, a digital to analog converter (DAC) 1174, a LO 918, a mixer 920, and an amplifier 1102.

As shown in FIG. 12B, type-2 active structure 1250 includes an antenna 902, an energy harvesting module 1154, an energy storage and power management 905, a BPF 956, an amplifier 1152, a mixer 1186, an envelope detector 1158, a comparator/ADC 910, a baseband 912, a memory 914, processing circuitry 913, a modulator 1172, a DAC 1174, a LO 1178, a mixer 1177, and an amplifier 1102.

FIGS. 12A and 12B illustrate example Type-2 active device structures.

The Type-2 active device shares similar structure at large with the Type-2 passive device other than the D2R signal is internally generated using LO rather than backscattering the externally provided CW. The example architecture shown in FIG. 11 is based on a common active transmitter chain, wherein the D2R data is modulated, converted to an analog signal using digital to analog converter (DAC) and, then up-converted to a D2R carrier frequency using LO and frequency mixer, which is followed by an amplifier.

In the implementation A, the R2D receiver chain is still based on the RF envelop detector as in the previous architectures. In the implementation B, the R2D receiver chain is based on intermediate frequency (IF), or baseband (BB) envelop detection. In the heterodyne architecture, the RF signal is down converted into an intermediate frequency and then detected using an envelope detector. In the homodyne/zero-IF architecture, the RF signal is directly down converted into baseband signal and then detected using an envelope detector.

FIGS. 9-12 should be understood for illustration purpose only. There can be other components not explicitly shown in the figure such as switch, duplexer, and filters, or some components may be replaced to different options. Also, the devices can operate both in TDD and FDD spectrum and, depending on the operating spectrum, the actual architectures can be different from the conceptual illustrations in the figures.

In deploying A-IoT devices, different topology options can be evaluated. The following provides examples of topology options:
Topology 1: BS↔A-IoT device
   An A-IoT device directly and bidirectionally communicates with a base station. The communication between the base station and the A-IoT device includes A-IoT data and/or signalling. This topology includes the BS transmitting to the A-IoT device is a different from the BS receiving from the A-IoT device.
Topology 2: BS↔intermediate node↔Ambient IoT device
   An A-IoT device communicates bidirectionally with an intermediate node between the device and base station. In this topology, the intermediate node can be a relay, IAB node, UE, repeater, etc. which is capable of A-IoT. The intermediate node transfers A-IoT data and/or signalling between BS and the A-IoT device. The intermediate node is referred to as I-node in this disclosure.
Topology 3: BS↔assisting node↔Ambient IoT device↔BS
   An A-IoT device transmits data/signaling to a base station, and receives data/signaling from the assisting node; or the A-IoT device receives data/signaling from a base station and transmits data/signaling to the assisting node. In this topology, the assisting node can be a relay, IAB, UE, repeater, etc. which is capable of A-IoT.
Topology 4: UE↔Ambient IoT device
   An A-IoT device communicates bidirectionally with a UE. The communication between UE and the A-IoT device includes A-IoT data and/or signaling.

This disclosure is applicable at least to the following deployment scenarios:
Scenario 1: Device indoors, BS indoors
Scenario 2: Device indoors, BS outdoors
Scenario 3: Device indoors, UE-based reader
Scenario 4: Device outdoors, BS outdoors
Scenario 5: Device outdoors, UE-based reader

The deployment of A-IoT can be on the same sites as an existing 3GPP deployment corresponding to the BS type, e.g., macro-cell, micro-cell, pic-cell, etc. In some embodiments, it may be assumed that the deployment of A-IoT can be on new sites without an assumption of an existing 3GPP deployment. The deployment can be based on licensed or unlicensed TDD or FDD spectrum, which may be in-band to an existing deployment, in guard-band of an existing deployment, or in a standalone band. Different traffic types can be supported including device-terminated (DT) and device-originated (DO), wherein DO traffic can be further divided into DO autonomous (DO-A), and DO device-terminated triggered (DO-DTT) types.

A-IoT device is one type of a UE. Embodiments in this disclosure can be generally applicable to other types of UEs, e.g., smartphones, AR/VR devices, or any other types of IoT devices.

Any operations performed by BS in this disclosure can be also performed by I-node instead of the BS, and each or part of interfaces are transparent to the A-IoT devices.

For precise synchronization, the SFO requirement to NR is within ±0.1 parts per million (PPM). In comparison, taking RFID as a reference, SFO for A-IoT may be ±10-20 PPM. Given the low complexity and the low power consumption requirements for A-IoT devices, it is apparent that the oscillators equipped with A-IoT devices will be significantly subpar to that equipped with a normal NR UE. It is therefore impractical to assume a precise timing capability for A-IoT devices as it is usually assumed for normal NR UEs. Furthermore, given that A-IoT devices are powered by harvesting energy, the device maybe running out of power time to time and, thereby, loosing timing, i.e., lacking timing maintaining capability.

Therefore, embodiments of the present disclosure recognize that there is a need to define procedures and methods for A-IoT devices to transmit an D2R signal and receive a R2D signal in a lack of frame synchronization.

Embodiments of the present disclosure further recognize that there is another need to define R2D/D2R signal structures for the reception in a system lacking a frame synchronization.

Also, embodiments of the present disclosure further recognize that there is a need to define procedures and methods for the determination of errors in the received R2D/D2R signals.

The disclosure relates to a communication system. The disclosure relates to defining functionalities and procedures for communication with A-IoT devices which may be lacking a precise timing capability and may operate in a passive or active D2R transmission mode.

The disclosure relates to defining functionalities and procedures for A-IoT devices to transmit an D2R signal and receive a R2D signal in a lack of frame synchronization.

The disclosure also relates to defining R2D/D2R signal structures for the reception in a system lacking a frame synchronization.

The disclosure further relates to defining functionalities and procedures for the determination of errors in the received R2D/D2R signals.

A description of example embodiments is provided on the following pages.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Embodiments of the disclosure for communication with A-IoT devices, which may be lacking a precise timing capability and may operate in a passive or active D2R transmission mode, are summarized in the following and are fully elaborated further herein.
Method and apparatus for defining functionalities and procedures for A-IoT devices to transmit an D2R signal and receive a R2D signal in a lack of frame synchronization.
Method and apparatus for defining R2D/D2R signal structures for the reception in a system lacking a frame synchronization.
Method and apparatus for defining functionalities and procedures for the determination of errors in the received R2D/D2R signals.

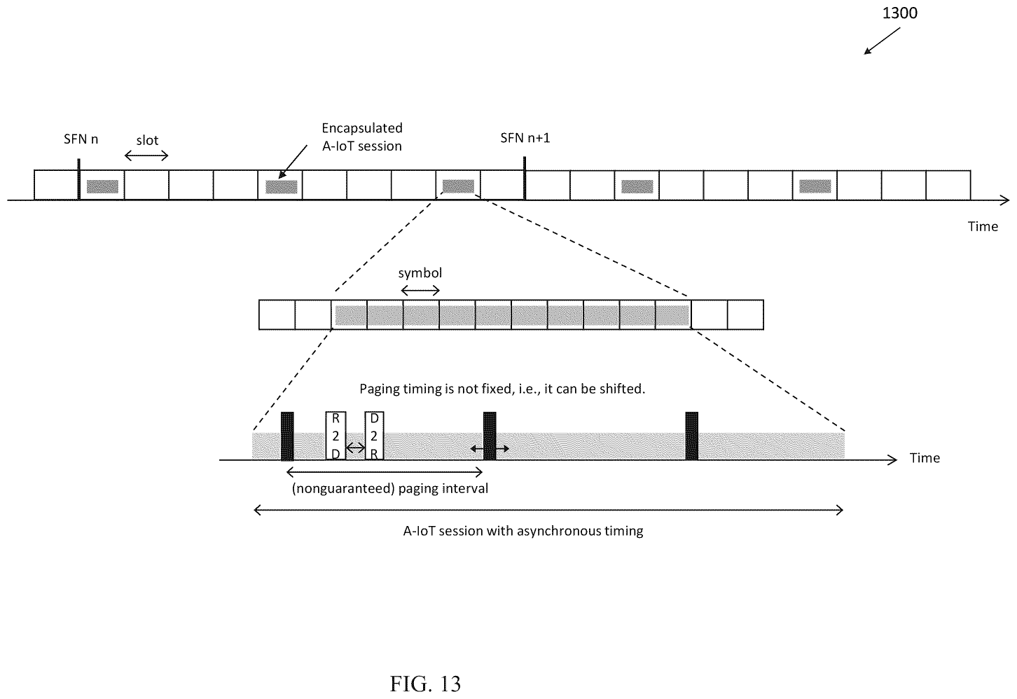

FIG. 13 illustrates a timeline for reader-triggered asynchronous system timing synchronization 1300 according to embodiments of the present disclosure. For example, reader-triggered asynchronous system timing synchronization 1300 can be triggered by the gNB 102 and/or network 130 in the wireless network 100 of FIG. 1, and followed by the IoT devices described herein. This example is for illustration only and other embodiments can be used without departing from the scope of the present disclosure.

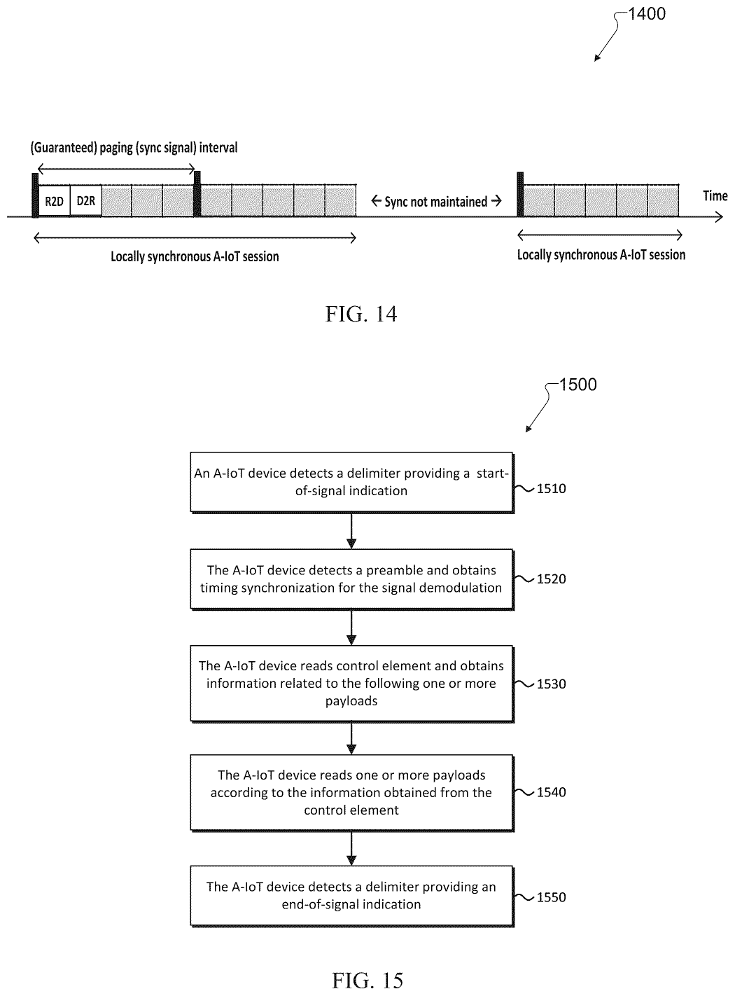

FIG. 14 illustrates a timeline for a reader-triggered locally synchronous system timing synchronization 1400 according to embodiments of the present disclosure. For example, reader-triggered locally synchronous system timing synchronization 1400 can be triggered by the gNB 102 and/or network 130 in the wireless network 100 of FIG. 1, and followed by the IoT devices described herein. This example is for illustration only and other embodiments can be used without departing from the scope of the present disclosure.

FIG. 13 illustrates an example reader-triggered asynchronous system with relative timing according to the disclosure.

In FIG. 13, the A-IoT deployment is in-band to an existing deployment of a synchronous system, in which there exist coexistence issues between A-IoT devices and other general UEs. The time/frequency resources used for A-IoT communication sessions may be indicated to other general UEs as reserved resources such that the other general UEs do not receive any periodic R2D signals or channels such as PDCCH, semi-persistent scheduling (SPS)PDSCH, any types of RSs, e.g., CSI-RS, positioning reference signal (PRS), tracking reference signal (TRS), phase tracking reference signal (PT-RS), and do not transmit any periodic D2R signals or channels such as scheduling request (SR), physical random access channel (PRACH), physical uplink control channel (PUCCH), hybrid automatic repeat request acknowledgement (HARQ ACK), CSI report, configured grant PUSCH (CG-PUSCH), sounding reference signal (SRS). The general UEs may be provided from a serving cell a set of parameters related to frequency domain reserved resources, e.g., RB/resource block group (RBG) indexes, RB/RBG ranges, BWP, or frequency ranges, and a set of parameters related to time domain reserved resources, e.g., periodicity, offset, duration.

From an A-IoT device perspective, it may or may not be aware of a coexistence with other general UEs. In the case when A-IoT devices are agnostic to other general UEs, in-band coexistence is maintained by the reader. This can be done by encapsulating an asynchronous A-IoT communication session in a synchronous system frame structure and as any D2R transmissions are triggered by the reader with relative timing relationship. In a standalone deployment, A-IoT session may be continuous.

If a paging signal is detected by an A-IoT device, the A-IoT device may expect a R2D reception or D2R transmission. Otherwise, if a paging signal is not detected for a certain time duration, the A-IoT device may assume that the A-IoT communication session is terminated or there is no nearby gNB (e.g., the gNB 102). Therefore, in this case, the paging signal serves the purpose of wake-up signal for A-IoT devices.

The paging signal may also provide system information. In this case, the control information indicates that the following payload includes system information. Some of the system information that can be taken into account to be provided includes physical cell ID (PCI), channel BW, and parameters related to the random access. The paging signal may be also utilized for R2D pathloss measurement and D2R power control.

FIG. 14 illustrates an example of a reader-triggered locally synchronous system according to the disclosure.

The network initiates the A-IoT communication session by transmitting a paging. Once the paging is received from a gNB, an A-IoT device expects that the transmission interval between the successive pagings are fixed at least during the current A-IoT session, given that the pagings serve as a timing reference signal. Taking into account the achievable SFO for A-IoT devices, there may be non-negligible clock drift between the two successive pagings.
The paging interval is determined such that the timing drift within a paging interval results less than ±X % of a slot duration.
Provisioning of a guard time between slots taking into account the timing drift.
Adding a preamble signal to R2D/D2R transmissions such that each signal provides their own timing information.

The paging interval and/or the guard time is provided to the UE (e.g., the UE 116) in the paging message itself, in a system information or predefined in the specifications of the system operation. The interval/guard time may be in terms of absolute time, e.g., in ms, an integer multiple of certain time unit, such as basic time unit, symbol duration, or chip duration. When indicated, it can be indicated in its absolute value or as an index from a set of predefined value.

The attachment of preamble to R2D/D2R transmissions may be predefined in the specifications of the system operation or indicated to the UE, e.g., in a paging message or in a system information.

FIG. 15 illustrates a flowchart of an example procedure 1500 for receiving a R2D signal according to embodiments of the present disclosure. For example, procedure 1500 can be performed by the IoT devices described herein. This example is for illustration only and other embodiments can be used without departing from the scope of the present disclosure.

The procedure begins in 1510, an A-IoT device detects a delimiter providing a start-of-signal indication. In 1520, the A-IoT device detects a preamble and obtains timing synchronization for the signal demodulation. In 1530, the A-IoT device reads control element and obtains information related to the following one or more payloads. In 1540, the A-IoT device reads one or more payloads according to the information obtained from the control element. In 1550, the A-IoT device detects a delimiter providing an end-of-signal indication.

FIG. 16 illustrates a flowchart of an example procedure 1600 for generating an uplink (UL) signal according to embodiments of the present disclosure. For example, procedure 1600 can be performed by an A-IoT device, such as IoT devices 900, 950, 1100, 1150, 1200, 1250, 2300, 2400, 2500, 2600, 2700, 2800, or 2900. This example is for illustration only and other embodiments can be used without departing from the scope of the present disclosure.

The procedure begins in 1610, an A-IoT device generates a delimiter providing a start-of-signal indication. In 1620, the A-IoT device generates a preamble signal. In 1630, the A-IoT device generates control element providing information related to the following one or more payloads. In 1640, the A-IoT device generates one or more payloads according to the generated control element. In 1650, the A-IoT device generates a delimiter providing an end-of-signal indication.

FIG. 15 illustrates an example flowchart of an A-IoT device to receive a R2D signal according to the disclosure.

FIG. 16 illustrates an example flowchart of an A-IoT device to generate an D2R signal according to the disclosure.

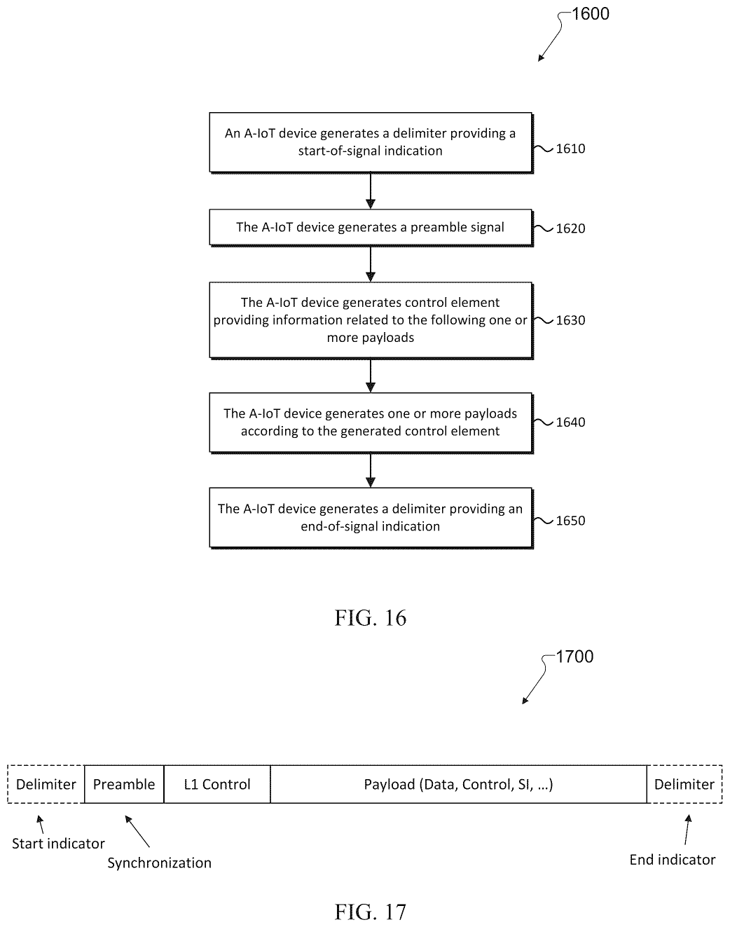

FIG. 17 illustrates a diagram of an example R2D/D2R signal architecture 1700 according to embodiments of the present disclosure. For example, R2D/D2R signal architecture 1700 can be transmitted/received to/from the gNB 102 and/or network 130 and in the wireless network 100 of FIG. 1 and the IoT devices described herein. This example is for illustration only and other embodiments can be used without departing from the scope of the present disclosure.

The R2D/D2R signal may be comprised of one or more of a start-of-signal delimiter, a preamble, one or more midambles and the associated payloads, a postamble, and an end-of-signal delimiter. In one example, the signal does not include the start-of-signal and the end-of-signal delimiters. In this case, the A-IoT device utilizes the preamble for the R2D signal for the detection of the start of the signal. The one or more midambles and the postamble may or may not be present depending on the payload size.

FIG. 17 illustrates an example of a basic R2D/D2R signal structure according to the disclosure.

Evaluating the low complexity requirements of A-IoT devices, R2D signals/channels and D2R signals/channels may be based on a common R2D signal structure and a common D2R signal structure, respectively, which can be reused for transmitting or receiving different types of R2D/D2R information. For instance, for R2D transmission, the control element (CE) in the signal can indicate whether the signal is, at least, for R2D control information, system information (SI), or R2D data. Similarly, for D2R transmission, the CE can indicate whether the signal is, at least, for D2R control information, or D2R data. To this end, only one physical channel for downlink and only one physical channel for uplink may be defined, which can be referred to as:
Physical reader to device channel (PRDCH):
   PRDCH serves the purposes of PDSCH, PDCCH, physical broadcast channel (PBCH) from NR standpoint.
Physical device to reader channel (PDRCH):
   PDRCH serves the purposes of PUSCH, PUCCH, PRACH from NR standpoint.

It is expected that reusing a common signal structure and indicating different signal types using CE will significantly simplify the baseband processing of A-IoT devices, rather than defining multiple different types of physical channels as in NR.

Depending on different types of signals or channels, only a subset of the fields in the figure may be included in a signal/channel.
Delimiter: Start-of-signal and end-of-signal indication. It may be a shorter lower complexity signal for detection compared to the preamble. In some design, the preamble may also serve the purpose and, thereby, the delimiters may not be present, i.e., the preamble includes the start-of-signal delimiter
Preamble: A signal for low-complexity presence detection, which can be implemented, e.g., using shift registers. The preamble signal can be a sequence transmitted in a time and/or frequency domain, which can be an on-off time pattern in its simplistic form. The preamble signal also provides timing synchronization for the demodulation of the following fields such as CE and one or more payloads. It may be also used for channel estimation, e.g., for setting up the automatic gain control (AGC), etc. The preamble immediately follows the start-of-signal delimiter, without any time gap, or the start-of-signal delimiter is a part of preamble, placed in the beginning of the preamble and another signal for synchronization immediately follows it. The preamble is immediately followed by the following PRDCH. For D2R, there may be no separate start-of-signal delimiter and the preamble is immediately followed by the following PDRCH.
Control element (CE): The CE field carries necessary information for R2D reception or D2R transmission similar to NR DCI formats. Some additional control information may be contained in the payload, whose handling may be similar to NR MAC CE and MAC service data unit (SDU). CE may be comprised of the following sub-elements.
   Signal type: Indicator for the signal type conveyed in the payload, e.g., R2D control information, D2R control information, R2D data, D2R data, SI, etc.
   Source ID: Transmitter ID of the signal. For R2D, it's the reader's ID, i.e., PCI. For D2R, it's a device ID, which may be an assigned ID from the gNB or an ID associated with the device itself.
   Destination ID: ID of the intended receiver of the signal. For D2R, it's the reader's ID, i.e., PCI. For R2D, it may indicate an associated ID of a specific A-IoT device or a group ID for a specific set of A-IoT devices. For broadcast information, e.g., system information, this field may indicate NULL or PCI, which is intended to be received by the devices served by the gNB.
   Length: This field indicates the length of the following payload, e.g., in number of bits, in number of symbols or chips, or in a certain time span. In another example, the payload size is fixed and predefined by the specifications of the system operation. In this case, if the information bits are smaller than the fixed payload size, the UE appends 0's to match the size.
Payload: In accordance with the indicated signal type in the CE, i.e., it can be R2D control information, D2R control information, R2D data, D2R data, SI, etc.

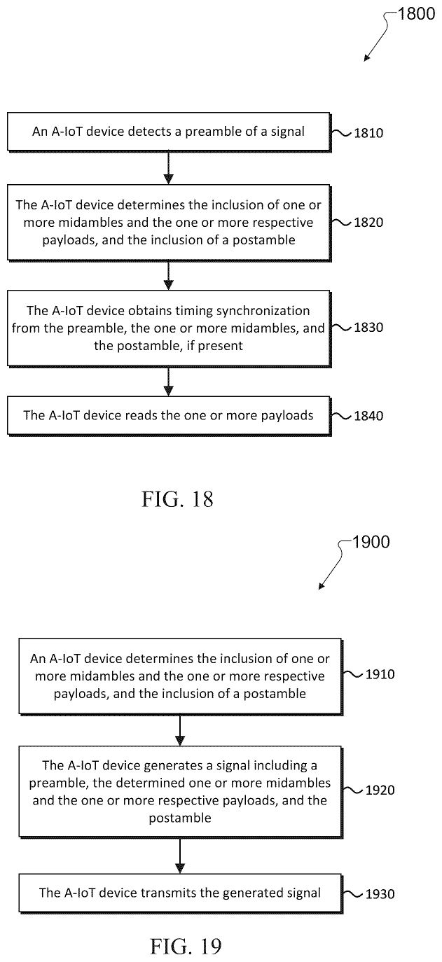

FIG. 18 illustrates a flowchart of an example procedure 1800 for receiving a R2D signal according to embodiments of the present disclosure. For example, procedure 1800 can be performed by the IoT devices described herein. This example is for illustration only and other embodiments can be used without departing from the scope of the present disclosure.

The procedure begins in 1810, an A-IoT device detects a preamble of a signal. In 1820, the A-IoT device determines the inclusion of one or more midambles and the one or more respective payloads, and the inclusion of a postamble. In 1830, the A-IoT device obtains timing synchronization from the preamble, the one or more midambles, and the postamble, if present. In 1840, the A-IoT device reads the one or more payloads.

FIG. 18 illustrates an example flowchart of an A-IoT device to receive a R2D signal including one or more midambles/payloads and a postamble according to the disclosure.

FIG. 19 illustrates a flowchart of an example procedure 1900 for generating and transmitting a D2R signal according to embodiments of the present disclosure. For example, procedure 1900 can be performed by an A-IoT device, such as IoT devices 900, 950, 1100, 1150, 1200, 1250, 2300, 2400, 2500, 2600, 2700, 2800, or 2900. This example is for illustration only and other embodiments can be used without departing from the scope of the present disclosure.

The procedure begins in 1910, an A-IoT device determines the inclusion of one or more midambles and the one or more respective payloads, and the inclusion of a postamble. In 1920, the A-IoT device generates a signal including a preamble, the determined one or more midambles and the one or more respective payloads, and the postamble. In 1930, the A-IoT device transmits the generated signal.

FIG. 19 illustrates an example flowchart of an A-IoT device to generate and transmit an D2R signal including one or more midambles/payloads and a postamble according to the disclosure.

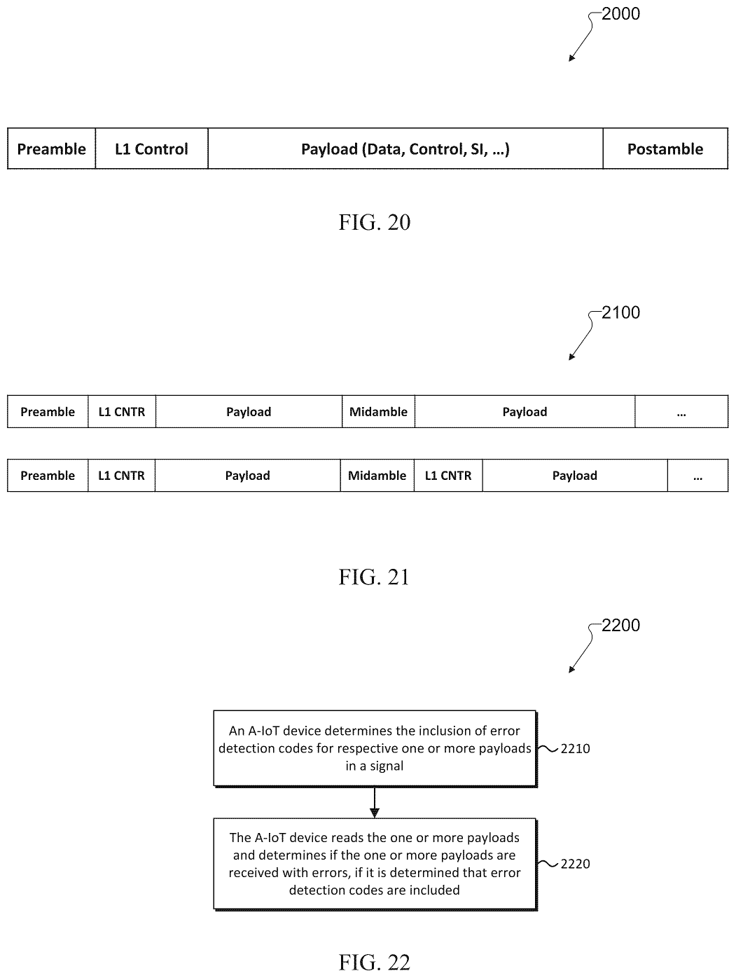

FIG. 20 illustrates a diagram of an example R2D/D2R signal architecture 2000 according to embodiments of the present disclosure. For example, R2D/D2R signal architecture 2000 can be transmitted/received to/from the gNB 102 and/or network 130 in the wireless network 100 of FIG. 1 and the IoT devices described herein. This example is for illustration only and other embodiments can be used without departing from the scope of the present disclosure.

FIG. 21 illustrates a diagram of an example R2D/D2R signal architecture 2100 according to embodiments of the present disclosure. For example, R2D/D2R signal architecture 2100 can be transmitted/received to/from the gNB 102 and/or network 130 in the wireless network 100 of FIG. 1 and the IoT devices described herein. This example is for illustration only and other embodiments can be used without departing from the scope of the present disclosure.

FIG. 20 illustrates an example of a R2D/D2R signal structure with postamble according to the disclosure.

In one example, the presence of postamble in a R2D transmission is indicated in the CE. In another example, if the payload size is greater than a certain predetermined value, e.g., in number of bits, in number of symbols or chips, or in a certain time span, in the specification of a system operation or a configured value in the paging or a system information, the A-IoT device expects the presence of a postamble. Otherwise, the A-IoT device does not expect the presence of postamble. The postamable may be the same sequence as preamble, a time reversal of the preamble, a [complex] conjugate of the preamble, or simply a delimiter.

For D2R transmission, the same rule may apply as disclosed herein. Further alternatively, the A-IoT device may be indicated to append the postamble from the reader in the preceding R2D transmission scheduling the D2R transmission.

Depending on the length of the payload field, the receiver may lose chip synchronization for data demodulation due to a timing drift or successive 0's and 1's depending on the modulation scheme. Therefore, there may be a need to consider a midamble to help the receiver to maintain the synchronization as illustrated in the figure herein.

FIG. 21 illustrates an example of a R2D/D2R signal structures with midamble according to the disclosure. In the first structure, the signal include CE only in the beginning, while in the second structure, the signal includes one or multiple CEs corresponding to the respective one or more payloads. In the first structure, the CE provides control information of the subsequent one or more payloads. In the second structure, each CE provides control information for the following associated payload.

In one example, the presence of midamble and/or the number of midambles and payloads included in a R2D transmission is indicated in the CE. For the second structure in the figure, the CE fields provide the count of the remaining number of the subsequent midambles and payloads. For instance, the first CE indicates N, and the second CE indicates N−1, for a transmission comprised of total N payloads and midambles. In another example, if the total payload size is greater than a certain predetermined value, e.g., in number of bits, in number of symbols or chips, or in a certain time span, in the specification of a system operation or a configured value in the paging or a system information, the A-IoT device expects the presence of one or more midambles and the corresponding payloads. For instance, if the indicated payload size is Sₜₒₜₐₗ, while a maximum payload size per any given payload is Sₘₐₓ, then the UE assume that the total number of payloads and the associated midambles is given by [Sₜₒₜₐₗ/Sₘₐₓ]. The midamable may be the same sequence as preamble, a time reversal of the preamble, a [complex] conjugate of the preamble, or simply a shorter delimiter. The midamble may have an alternating signal between the n-th and n+1-th midambles, where n is an integer greater than or equal to zero.

For D2R transmission, the same rule may apply as disclosed herein. Further alternatively, the A-IoT device may be indicated regarding the segmentation of the payload, such as the maximum block size that can be encoded in one payload. If the total payload size is greater than the indicated maximum payload size, the A-IoT shall encode the transmission block into multiple payloads with the specified maximum size. In addition, the A-IoT devices may be also indicated the maximum number of payloads that the A-IoT device can transmit in one transmission.

If the R2D/D2R signal does not include an end-of-signal delimiter, the A-IoT device may assume zero padding for R2D reception or perform zero padding for D2R transmission for the size mating to the indicated or predefined payload size for the single payload, or the last payload, if the signal includes more than one payloads.

In one example, if a payload size is smaller than a first threshold, then the signal only includes a preamble. In another example, if a payload size is greater than a first threshold but smaller than a second threshold, the signal includes a preamble and a postamble. In further another example, if a payload size is greater than a second threshold, the signal includes one or more midambles and the associated payloads, in addition to the preamble or the preamble and the postamble.

The criteria for having a postamble or midamble may be provided in a paging message and/or as a part of system information.

FIG. 22 illustrates a flowchart of an example procedure 2200 for receiving a R2D signal according to embodiments of the present disclosure. For example, procedure 2200 can be performed by the IoT devices described herein. This example is for illustration only and other embodiments can be used without departing from the scope of the present disclosure.

The procedure begins in 2210, an A-IoT device determines the inclusion of error detection codes for respective one or more payloads in a signal. In 2220, the A-IoT device reads the one or more payloads and determines if the one or more payloads are received with errors, if it is determined that error detection codes are included.

FIG. 22 illustrates an example flowchart of an A-IoT device to receive a R2D signal including one or more payloads with respective error detection codes according to the disclosure.

In one example, the R2D/D2R signals include error detection codes, such as parity bits or cyclic redundancy check (CRC) bits. In one example, the error detection codes are assumed to be included when the payload size is greater than a certain threshold. In further another example, N₁-bit CRC is assumed to be attached for a payload size smaller than a certain threshold and N₂-bit CRC is assumed to be attached for a payload size greater than or equal to the certain threshold. In these examples, the certain threshold on the payload size may be predefined in the specifications of the system operation or indicated to the A-IoT devices, e.g., in the paging and/or as a part of SI. In yet another example, for D2R transmission, the A-IoT device is indicated by the reader on the inclusion of error detection codes in the preceding R2D transmission.

Furthermore, R2D/D2R transmissions may be encoded with error correction codes, such as a kind of block code, e.g., Hamming code, or a convolutional code. Similar rules as disclosed for the inclusion of error detection codes may apply such that the A-IoT device expects the error detection codes depending on the payload size or per indication from the reader.

Several different types of A-IoT devices can be evaluated as following.
Device 1: ˜1 μW peak power consumption, has energy storage, initial sampling frequency offset (SFO) up to 10×ppm, neither R2D nor D2R amplification in the device. The device's D2R transmission is backscattered on a carrier wave provided externally.
Device 2a: ≤ a few hundred μW peak power consumption, has energy storage, initial sampling frequency offset (SFO) up to 10×ppm, both R2D and/or D2R amplification in the device. The device's D2R transmission is backscattered on a carrier wave provided externally.
Device 2b: ≤ a few hundred μW peak power consumption, has energy storage, initial sampling frequency offset (SFO) up to 10×ppm, both R2D and/or D2R amplification in the device. The device's D2R transmission is generated internally by the device.

The devices may operate in FDD spectrum or TDD spectrum, which may be licensed or unlicensed.

In the following, reference architectures for the device types herein are provided, which should be understood as an example and not as a restriction.

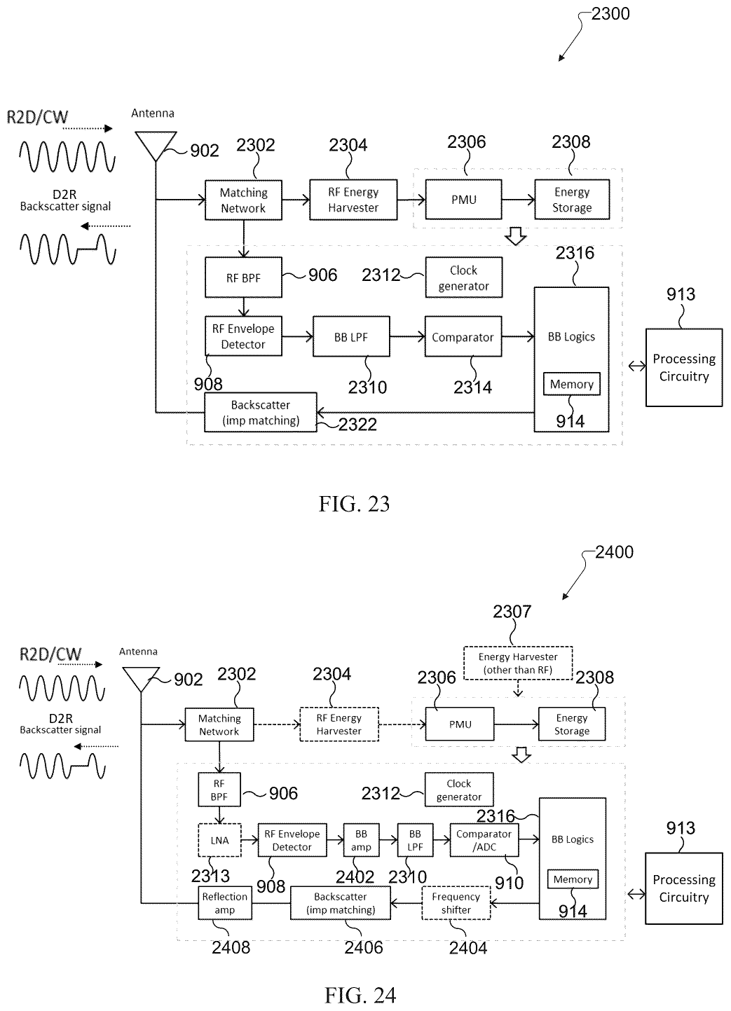

FIG. 23 illustrates a diagram of an example device 1 structure 2300 for IoT devices according to embodiments of the present disclosure. For example, device 1 structure 2300 can be implemented by a UE, such as UE 111 of FIG. 1, or may be devices with fewer components and functionality than a UE. This example is for illustration only and other embodiments can be used without departing from the scope of the present disclosure.

As shown in FIG. 23, the device 1 structure 2300 includes an antenna 902, a matching network 2302, a RF energy harvester 2304, a phase measurement unit (PMU) 2306, an energy storage 2308, a RF BPF 906, a RF envelope detector 908, a BB lowpass filter (LPF) 2310, a comparator 2314, a clock generator 2312, BB logistics 2316, memory 914, processing circuitry 913, and a backscatter (impedance matching) 2322.

FIG. 23 illustrates an example Type-1 backscatter device structure according to the disclosure.

The RF energy harvester 2304 converts RF signal to DC power and supplies to the device. Either a R2D signal or an externally provisioned CW signal for backscattering can be utilized for RF energy harvesting. The CW is externally provided from a gNB or a dedicated source. The source of CW signal, e.g., either a gNB or a dedicated node, may or may not be agnostic to A-IoT devices. The harvested energy, e.g., using a rectifier, can be stored using a capacitor, super-capacitor, or, generally speaking, an energy storage. Antenna 902 could be either shared or separate for RF energy harvester and receiver/transmitter. Matching network 2302 is to match impedance between antenna and other components. PMU 2306 manages storing energy to energy storage from energy harvester and suppling power to active component blocks which needs power supply. Clock generator 2312 provides required clock signal(s) to and is directly or indirectly connected to one or more of the components in the IoT device, including, for example and without limitation, the memory 914, processing circuitry 913, BB logistics 2316, and/or PMU 2306.

The R2D signal is demodulated using a low complexity envelop detector and comparator, whose output is provided as an input to the baseband circuit. Given the low-power and low-complexity requirements of the Type-1 backscatter device, an RF envelop detection can be a viable solution for a receiver architecture, compared to a heterodyne architecture with IF envelope detection or a homodyne architecture with baseband envelope detection, which require LO and frequency mixer for frequency down-conversion. The input RF signal passes through an RF band-pass filter (BPF) for an adjacent channel interference suppression, and then the filtered RF signal is directly converted into a baseband using an RF envelop detector, followed by a baseband low-pass filter (LPF) for filtering out harmonics and high frequency components, and an n-bit comparator, where n can be 1, 2, 4, 8, . . . . The use of filters, e.g., BPF only, LPF only, or both, can be an implementation choice.

For the D2R backscatter transmission, any of the following can be used:
Case 1) CW is provisioned at DL spectrum and backscattered, i.e., CW @ DL spectrum, D2R backscattering @ DL spectrum.
Case 2) CW is provisioned at UL spectrum and backscattered, i.e., CW @ UL spectrum, D2R backscattering @ UL spectrum.
Case 3) CW is provisioned at DL spectrum, frequency shifted to UL spectrum, and then backscattered, i.e., CW @ DL spectrum, D2R backscattering @ UL spectrum.

In one example, Case 1) or Case 2) is evaluated for device 1, i.e., CW and D2R backscattering on the same frequency and, therefore, a frequency shifter (FS) is not required.

FIG. 10 illustrates an example impedance matching circuit for backscatter device D2R modulation according to the disclosure.

The followings are simple examples of impedance matching operations:
Open circuit: Full reflection of the received CW signal in the same phase. This can be used for on-off keying (OOK) modulation with matching circuit.
Short circuit: Full reflection of the received CW signal in the reversed phase. This can be used for phase-shift keying (PSK) modulation.
Matching circuit: No reflection as the impedance is matched to a load, i.e., absorption. This can be utilized for energy harvesting, Rx mode, or modulation with other matching states.
Multi-level matching circuit: As illustrated in FIG. 10. Multi-level impedance matching to Z₁, Z₂, . . . , Z_{L} for log₂(L) bits per symbol ASK modulation.

Depending on the matched load impedance, the matching circuit can backscatter the incoming CW signal with different reflection coefficients in both amplitude and phase. In general, ASK/PSK/FSK may be supported using an impedance matching circuit. As a simplest modulation scheme, OOK may be considered. The device may indicate its modulation capability or impedance matching capability to the network, or certain requirement may be predefined in the specification of system operation.

FIG. 24 illustrates a diagram of an example device 2 structure 2400 for IoT devices according to embodiments of the present disclosure. For example, device 2 structure 2400 can be implemented by a UE, such as UE 112 of FIG. 1, or may be devices with fewer components and functionality than a UE. This example is for illustration only and other embodiments can be used without departing from the scope of the present disclosure.

As shown in FIG. 24, device 2 structure 2400 includes an antenna 902, a matching network 2302, a RF energy harvester 2304, a PMU 2306, an energy harvester (other than RF) 2307, an energy storage 2308, a RF BPF 906, a LNA 2313, RF envelope detector 908, a BB amplifier 2402, a BB LPF 2310, a comparator/ADC 910, a clock generator 2312, BB logistics 2316, memory 914, processing circuitry 913, a frequency shifter 2404, a backscatter (impedance matching) 2406, and a reflection amplifier 2408.

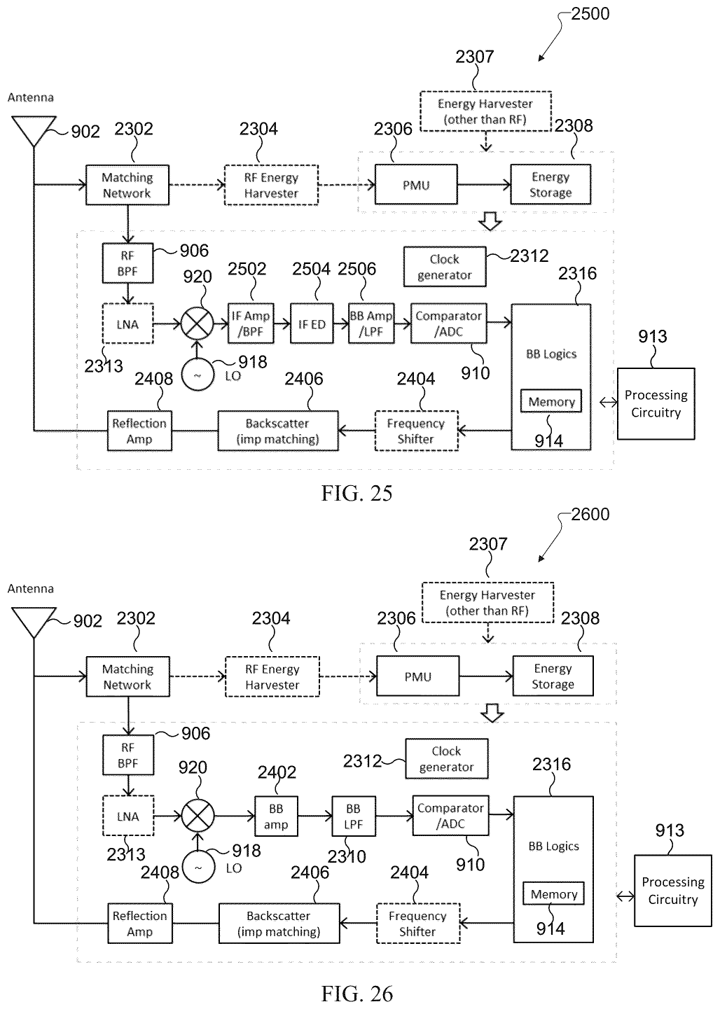

FIG. 25 illustrates a diagram of an example device 2a structure 2500 for IoT devices according to embodiments of the present disclosure. For example, device 2a structure 2500 can be implemented by a UE, such as UE 113 of FIG. 1, or may be devices with fewer components and functionality than a UE. This example is for illustration only and other embodiments can be used without departing from the scope of the present disclosure.

As shown in FIG. 25, the device 2a structure 2500 includes an antenna 902, a matching network 2302, a RF energy harvester 2304, a PMU 2306, an energy harvester (other than RF) 2307, an energy storage 2308, a RF BPF 906, a LNA 2313, a mixer 920, a LO 918, an IF amp/BPF 2502, an IF ED 2504, a BB Amp/LPF 2506, a comparator/ADC 910, a clock generator 2312, BB logistics 2316, memory 914, processing circuitry 913, a frequency shifter 2404, a backscatter (impedance matching) 2406, and a reflection amplifier 2408.

FIG. 26 illustrates a diagram of an example device 2a structure 2600 for IoT devices according to embodiments of the present disclosure. For example, device 2a structure 2600 for IoT devices can be implemented by a UE, such as UE 114 of FIG. 1, or may be devices with fewer components and functionality than a UE. This example is for illustration only and other embodiments can be used without departing from the scope of the present disclosure.

As shown in FIG. 26, the device 2a structure 2600 includes an antenna 902, a matching network 2302, a RF energy harvester 2304, a PMU 2306, an energy harvester (other than RF) 2307, an energy storage 2308, a RF BPF 906, a LNA 2313, a mixer 920, a LO 918, a BB amplifier 2402, a BB LPF 2310, a comparator/ADC 910, a clock generator 2312, BB logistics 2316, memory 914, processing circuitry 913, a frequency shifter 2404, a backscatter (impedance matching) 2406, and a reflection amplifier 2408.

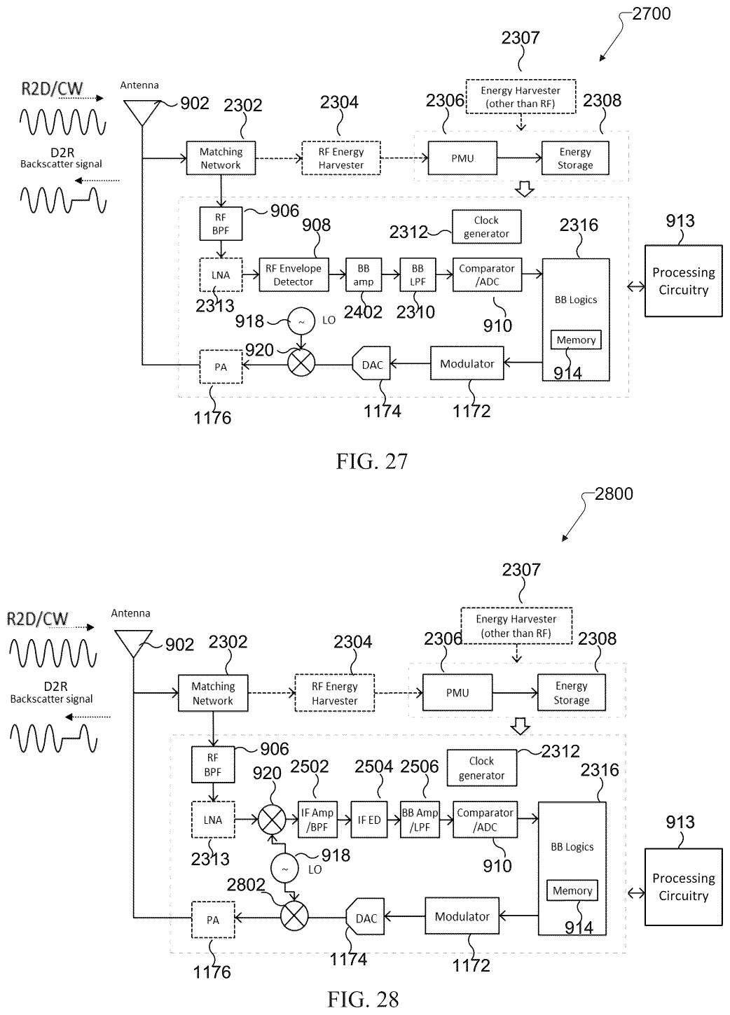

FIG. 27 illustrates a diagram of an example device 2b structure 2700 for IoT devices according to embodiments of the present disclosure. For example, device 2b structure 2700 can be implemented by a UE, such as UE 115 of FIG. 1, or may be devices with fewer components and functionality than a UE. This example is for illustration only and other embodiments can be used without departing from the scope of the present disclosure.

As shown in FIG. 27, the device 2b structure 2700 includes an antenna 902, a matching network 2302, a RF energy harvester 2304, a PMU 2306, an energy harvester (other than RF) 2307, an energy storage 2308, a RF BPF 906, a LNA 2313, a RF envelope detector 908, a mixer 920, a LO 918, a BB amplifier 2402, a BB LPF 2310, a comparator/ADC 910, a clock generator 2312, BB logistics 2316, memory 914, processing circuitry 913, a modulator 1172, a DAC 1174, and a PA 1176.

FIG. 28 illustrates a diagram of an example device 2b structure 2800 for IoT devices according to embodiments of the present disclosure. For example, device 2b structure 2800 can be implemented by a UE, such as UE 116 of FIG. 1, or may be devices with fewer components and functionality than a UE. This example is for illustration only and other embodiments can be used without departing from the scope of the present disclosure.

As shown in FIG. 28, the device 2b structure 2800 includes an antenna 902, a matching network 2302, a RF energy harvester 2304, a PMU 2306, an energy harvester (other than RF) 2307, an energy storage 2308, a RF BPF 906, a LNA 2313, a mixer 920, a LO 918, an IF amp/BPF 2502, an IF ED 2504, a BB Amp/LPF 2506, a comparator/ADC 910, a clock generator 2312, BB logistics 2316, memory 914, processing circuitry 913, a modulator 1172, a DAC 1174, a mixer 2802, and a PA 1176.

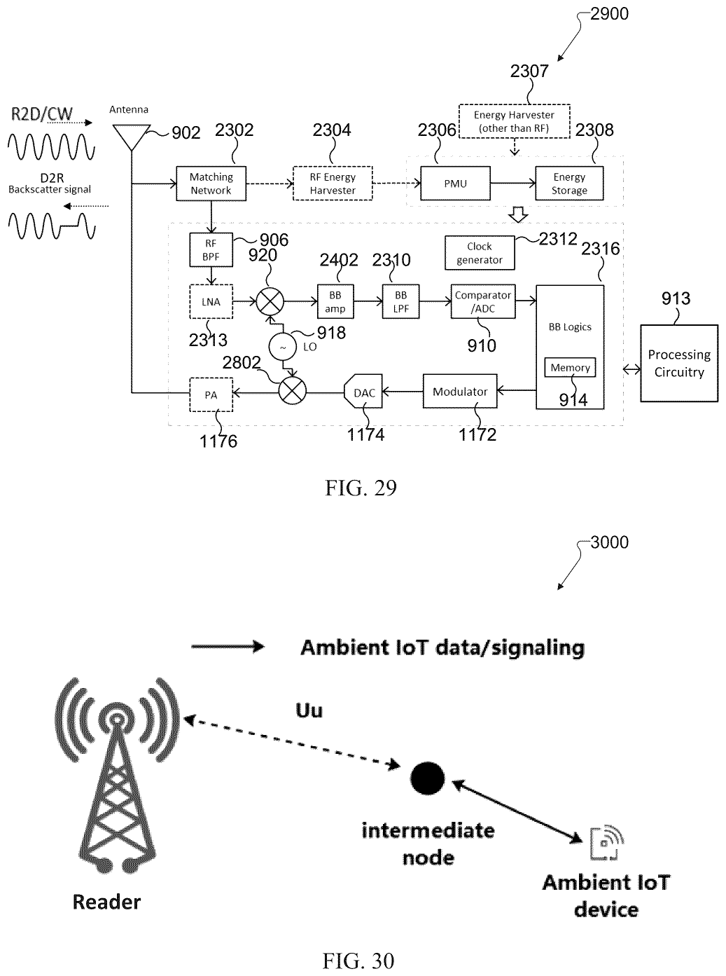

FIG. 29 illustrates a diagram of an example device 2b structure 2900 for IoT devices according to embodiments of the present disclosure. For example, device 2b structure 2900 can be implemented by a UE, such as UE 116 of FIG. 3, or may be devices with fewer components and functionality than a UE. This example is for illustration only and other embodiments can be used without departing from the scope of the present disclosure.

As shown in FIG. 29, the device 2b structure 2900 includes an antenna 902, a matching network 2302, a RF energy harvester 2304, a PMU 2306, an energy harvester (other than RF) 2307, an energy storage 2308, a RF BPF 906, a LNA 2313, a mixer 920, a LO 918, a BB amplifier 2402, a BB LPF 2310, a comparator/ADC 910, a clock generator 2312, BB logistics 2316, memory 914, processing circuitry 913, a modulator 1172, a DAC 1174, a mixer 2802, and a PA 1176.

FIG. 24 illustrates an example device 2a architecture based on RF envelop detection according to the disclosure.

The device 2a may share similar structure at large with device 1 as the D2R transmission is still based on backscattering of an externally provided CW, while the device 2a may differ from device 1 from the following aspects.

The device 2a has ≤ a few hundred μW peak power consumption and both R2D and/or D2R amplification in the device. In this case, alternative to the RF energy harvesting from a R2D signal or an externally provided CW signal, other renewable energy sources, e.g., solar, thermal, kinetic, etc., may be considered for energy harvesting. The presence of a certain energy harvesting capability from a certain renewable energy source may be assumed for system design point of view. The use of energy harvesters, e.g., RF energy harvester only, other energy harvester only, or both, can be an implementation choice.

The device 2a may be equipped with both R2D and/or D2R amplification in the device. Given the power consumption requirement, i.e., ≤ a few hundred μW, the R2D/D2R amplification for device 2a may be based on an architecture that is different from the common power amplifier (PA) and low noise amplifier (LNA). In some example low-power/complexity architectures for forward amplifier for reader-to-device (R2D) reception and reflection amplifier for device-to-reader (D2R) transmission, a single bipolar transistor terminated with microstrips may be used. The receiver amplification can be either RF amplification prior to the envelop detector, baseband amplification after the envelop detector, or both, which is an implementation choice. In one example, a reflection amplifier is used for both R2D (e.g., PRDCH) reception and D2R (e.g., PDRCH) transmission, and LNA may or may not exist. In another example, a reflection amplifier is used for D2R transmission only and LNA is used for R2D reception amplification.

In one example, a reflection amplifier can be used only for backscattering, i.e., one-way amplification. In another example, a reflection amplifier can be used for both backscattering and receiving, i.e., two-way amplification. For a reflection amplifier, it can be assumed that 10 ˜ 25 dB gain is achievable, at a power consumption of a few tens to hundreds micro-Watts. It is noted that an exact power consumption value will be highly dependent on implementations. On the other hand, a stability of an amplifier is a function of an input impedance and operating frequency. Since A-IoT devices are expected to be deployed for a certain operating frequency and not expected to adapt to another frequency after deployment, the implementation can ensure a stable operation of the amplifier for the target frequency.

One additional difference of device 2a compared to device 1 may be a use of a FS. With a few hundred μW peak power consumption, some low-power LO architectures with a frequency mixer can be considered for Case 3). With FS, it can be assumed that the CW is provided in a frequency different than the UL carrier frequency. Taking into account that the A-IoT devices are targeting for low complexity and low power consumption, the following options can be considered as an example method for frequency shift:
Ultra-low power local oscillator (LO), whose output frequency is multiplied in one or more stages using a frequency multiplier to obtain a desired amount of frequency shift.
Calibrated RC (resistor-capacitor) oscillator, which uses CW frequency as an input to the RC oscillator with phase locked loop (PLL) circuitry.
CW signal provided at the UL carrier frequency; In this case, no frequency shifter is needed.
Use of harmonic frequencies of CW signal or intermodulation frequencies of two-tone CW signals.

The device 2a receiver architecture may be based on RF envelop detector, intermediate frequency (IF) envelop detector, i.e., heterodyne receiver, or homodyne receiver with zero IF, as exemplified for device 2b.

FIG. 25 illustrates an example device 2a architecture based on IF envelop detection according to the disclosure.

FIG. 26 illustrates an example device 2a architecture based on baseband detection according to the disclosure.

FIG. 27 illustrates an example device 2b architecture based on RF envelop detection according to the disclosure.

FIG. 28 illustrates an example device 2b architecture based on heterodyne/IF-ED receiver according to the disclosure.

FIG. 29 illustrates an example device 2b architecture based on homodyne/zero-IF receiver according to the disclosure.

The device 2b shares similar structure at large with the device 2a other than the D2R signal is internally generated using LO rather than backscattering the externally provided CW. The example architecture shown in FIGS. 25-27 is based on a common active transmitter chain, wherein the D2R data is modulated, converted to an analog signal using digital to analog converter (DAC) and, then up-converted to a UL carrier frequency using LO and frequency mixer, which is followed by an amplifier.

In FIG. 25, the R2D receiver chain is still based on the RF envelop detector as in the previous architectures. In FIG. 26, the R2D receiver chain is based on heterodyne receiver with IF envelop detector. In the heterodyne architecture, the RF signal is down converted into an intermediate frequency and then detected using an envelope detector. In FIG. 27, the R2D receiver is based on homodyne receiver, i.e., zero-IF. In the homodyne/zero-IF architecture, the RF signal is directly down converted into baseband signal and then detected using a comparator/ADC.

FIGS. 23, 10, and 24-27 should be understood for illustration purpose only. There can be other components not explicitly shown in the figure such as switch, duplexer, and filters, or some components may be replaced to different options. Also, the devices can operate both in TDD and FDD spectrum, either licensed or unlicensed, and, depending on the operating spectrum, the actual architectures can be different from the conceptual illustrations in the figures.

In deploying A-IoT devices, different topology options can be considered. The following provides examples of topology options:
Topology 1: BS↔A-IoT device
   An A-IoT device directly and bidirectionally communicates with a base station. The communication between the base station and the A-IoT device includes A-IoT data and/or signalling. This topology includes the BS transmitting to the A-IoT device is a different from the BS receiving from the A-IoT device.
Topology 2: BS↔intermediate node↔Ambient IoT device
   An A-IoT device communicates bidirectionally with an intermediate node between the device and base station. In this topology, the intermediate node can be a relay, IAB node, UE, repeater, etc. which is capable of A-IoT. The intermediate node transfers A-IoT data and/or signalling between BS and the A-IoT device. The intermediate node is referred to as I-node in this disclosure.
Topology 3: BS↔assisting node↔Ambient IoT device↔BS
   An A-IoT device transmits data/signaling to a base station, and receives data/signaling from the assisting node; or the A-IoT device receives data/signaling from a base station and transmits data/signaling to the assisting node. In this topology, the assisting node can be a relay, IAB, UE, repeater, etc. which is capable of A-IoT.
Topology 4: UE↔Ambient IoT device
   An A-IoT device communicates bidirectionally with a UE. The communication between UE and the A-IoT device includes A-IoT data and/or signaling.

This disclosure is applicable at least to the following deployment scenarios:
Scenario 1: Device indoors, BS indoors
Scenario 2: Device indoors, BS outdoors
Scenario 3: Device indoors, UE-based reader
Scenario 4: Device outdoors, BS outdoors
Scenario 5: Device outdoors, UE-based reader

The deployment of A-IoT can be on the same sites as an existing 3GPP deployment corresponding to the BS type, e.g., macro-cell, micro-cell, pic-cell, etc. In some embodiments, it may be assumed that the deployment of A-IoT can be on new sites without an assumption of an existing 3GPP deployment. The deployment can be based on licensed or unlicensed TDD or FDD spectrum, which may be in-band to an existing deployment, in guard-band of an existing deployment, or in a standalone band. Different traffic types can be supported including device-terminated (DT) and device-originated (DO), wherein DO traffic can be further divided into DO autonomous (DO-A), and DO device-terminated triggered (DO-DTT) types.

A-IoT device is one type of a UE. Embodiments in this disclosure can be generally applicable to other types of UEs, e.g., smartphones, AR/VR devices, or any other types of IoT devices.

FIG. 30 illustrates an example system 3000 for D2R/R2D transmission including an intermediate node according to embodiments of the present disclosure. For example, system 3000 can be implemented in the wireless network 100 of FIG. 1. This example is for illustration only and other embodiments can be used without departing from the scope of the present disclosure.

FIG. 30 illustrates a topology involving an intermediate node, wherein the intermediate node (I-node) can be any of a UE, relay, repeater, a dedicated node, a reader, or a gNB. Any operations performed by a BS can be also performed by the I-node instead of the BS, and each or part of interfaces are transparent to the A-IoT devices.

An entity directly communicating with a device, or tag, is collectively termed as a reader, which can be an intermediate node as illustrated in FIG. 28, an assisting node, a UE, a reader, or a BS directly communicating with a device.

This disclosure is applicable to any of the following spectrum options, wherein a reader can be any of a BS, an intermediate node, an assisting node, or a UE in any of the topologies or scenarios disclosed earlier:
The scenario when a reader is an intermediate node, an assisting node, or a UE
   CW is transmitted on DL spectrum and D2R is transmitted on the DL spectrum or shifted to UL spectrum.
   CW is transmitted on UL spectrum and D2R is transmitted on the UL spectrum or shifted to DL spectrum.
   R2D transmission by a reader is on DL spectrum or UL spectrum.
   A node transmitting the CW can be a node inside the topology, e.g., a BS, an intermediate node, an assisting node, or a UE, or a node outside the topology, e.g., a dedicated CW source.
   A reader receiving D2R transmission and a reader transmitting R2D may be the same or different.
   As an example, CW is transmitted on DL spectrum and DER transmission is shifted to UL spectrum, wherein the node transmitting the CW is a node inside topology or outside topology, and a reader transmitting R2D and a reader receiving D2R may be the same or different.
   As another example, CW is transmitted on DL or UL spectrum and D2R transmission is on the same spectrum for which the CW is transmitted, wherein the node transmitting the CW is a node inside topology or outside topology, and a reader transmitting R2D and a reader receiving D2R may be the same or different.

A physical channel for reader to device transmission is referred to as a physical reader to device (R2D) channel (PRDCH), and a physical channel for device to reader transmission is referred to as a physical device to reader (D2R) channel (PDRCH) in this disclosure.

For PRDCH and PDRCH transmission, a timing acquisition signal, e.g., a preamble, immediately precedes PRDCH or PDRCH and provides functionalities such as timing acquisition and the start of the transmission indication in time domain, respectively.

There may be a timing relationship between transmissions as herein:
T_{R2D_min}, T_{R2D_max}: Minimum/maximum time between a R2D transmission and the corresponding D2R transmission following it.
T_{D2R_min}, T_{D2R_max}: Minimum/maximum time between a D2R transmission and the corresponding R2D transmission following it.
T_{R2D_R2D_min}, T_{R2D_R2D_max}: Minimum/maximum time between two different consecutive R2D transmissions to the same A-IoT device.
T_{D2R_D2R_min}, T_{D2R_D2R_max}: Minimum/maximum time between two different consecutive D2R transmissions from the same A-IoT device.

Given the low complexity and the low power consumption requirements for A-IoT devices, it is apparent that the oscillators equipped with A-IoT devices will be significantly subpar to that equipped with a normal NR UE. It is therefore impractical to assume a precise timing capability for A-IoT devices as it is usually assumed for normal NR UEs. Furthermore, given that A-IoT devices are powered by harvesting energy, the device maybe running out of power time to time and, thereby, loosing timing, i.e., lacking timing maintaining capability.

When asynchronous communication is assumed for transmission and reception between a reader and a device, a receiving node needs to identify a start of signaling and timing synchronization for the reception of a signal. Therefore, there is a need to define procedures and methods for a device to receive a preamble for R2D signal reception. There is another need to define procedures and methods for a device to generate and transmit a preamble for D2R signal transmission.

When a clock synchronization cannot be reliably assumed during the reception of a large payload size as in A-IoT system, there is a need for a receiving node to maintain the clock synchronization. Therefore, there is a need to define procedures and methods for a device to determine a presence of a midamble in the R2D signal reception and receive R2D signal accordingly. There is another need to define procedures and methods for a device to determine an insertion of a midamble in the D2R signal transmission and transmit D2R signal accordingly.

A length of a transmission may not be known or may be know but the timing can drift at the receiver. Therefore, there is a need to define procedures and methods for a device to receive a postamble for R2D signal reception and determine the end of R2D signal. There is another need to define procedures and methods for a device to determine an attachment of a postamble in the D2R signal transmission and transmit D2R signal accordingly.

The disclosure relates to a communication system. The disclosure relates to defining functionalities and procedures for communication with A-IoT devices which may be lacking a precise timing capability and may operate in a passive or active D2R transmission mode.

The disclosure relates to defining functionalities and procedures for A-IoT devices to transmit a D2R signal and receive a R2D signal in an asynchronous manner with a lack of precise synchronization maintenance capability.

The disclosure also relates to defining functionalities and procedures for A-IoT devices to receive a preamble for R2D signal reception.

The disclosure also relates to defining functionalities and procedures for A-IoT devices to generate and transmit a preamble for D2R signal transmission.

The disclosure further relates to defining functionalities and procedures for A-IoT devices to determine a presence of a midamble in the R2D signal reception and receive R2D signal accordingly.

The disclosure also relates to defining functionalities and procedures for A-IoT devices to determine an insertion of a midamble in the D2R signal transmission and transmit D2R signal accordingly.

The disclosure further relates to defining functionalities and procedures for A-IoT devices to receive a postamble for R2D signal reception and determine the end of R2D signal.

The disclosure also relates to defining functionalities and procedures for A-IoT devices to determine an attachment of a postamble in the D2R signal transmission and transmit D2R signal accordingly.

Embodiments of the disclosure for communication with A-IoT devices, which may be lacking a precise timing capability and may operate in a passive or active D2R transmission mode, are summarized in the following and are fully elaborated further herein.
Method and apparatus for defining functionalities and procedures for A-IoT devices to receive a preamble for R2D signal reception.
Method and apparatus for defining functionalities and procedures for A-IoT devices to generate and transmit a preamble for D2R signal transmission.
Method and apparatus for defining functionalities and procedures for A-IoT devices to determine a presence of a midamble in the R2D signal reception and receive R2D signal accordingly.
Method and apparatus for defining functionalities and procedures for A-IoT devices to determine an insertion of a midamble in the D2R signal transmission and transmit D2R signal accordingly.
Method and apparatus for defining functionalities and procedures for A-IoT devices to receive a postamble for R2D signal reception and determine the end of R2D signal.
Method and apparatus for defining functionalities and procedures for A-IoT devices to determine an attachment of a postamble in the D2R signal transmission and transmit D2R signal accordingly.

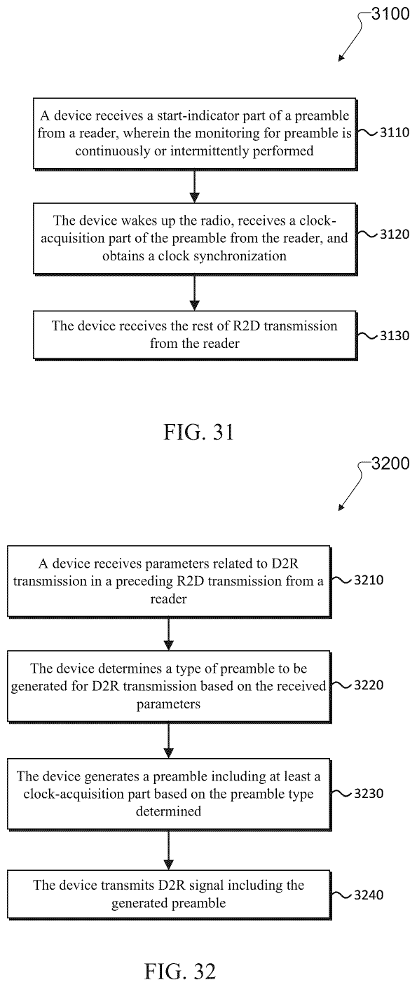

FIG. 31 illustrates a flowchart of an example procedure 3100 for receiving a reader to device (R2D) preamble according to embodiments of the present disclosure. For example, procedure 3100 can be performed by an A-IoT device, such as IoT devices 900, 950, 1100, 1150, 1200, 1250, 2300, 2400, 2500, 2600, 2700, 2800, or 2900. This example is for illustration only and other embodiments can be used without departing from the scope of the present disclosure.

The procedure begins in 3110, a device receives a start-indicator part of a preamble from a reader, wherein the monitoring for preamble is continuously or intermittently performed. In 3120, the device wakes up the radio, receives a clock-acquisition part of the preamble from the reader, and obtains a clock synchronization. In 3130, the device receives the rest of R2D transmission from the reader.

FIG. 32 illustrates a flowchart of an example procedure 3200 for generating a device to reader (D2R) preamble according to embodiments of the present disclosure. For example, procedure 3200 can be performed by the IoT devices described herein. This example is for illustration only and other embodiments can be used without departing from the scope of the present disclosure.

The procedure begins in 3210, a device receives parameters related to D2R transmission in a preceding R2D transmission from a reader. In 3220, the device determines a type of preamble to be generated for D2R transmission based on the received parameters. In 3230, the device generates a preamble including at least a clock-acquisition part based on the preamble type determined. In 3240, the device transmits D2R signal including the generated preamble.

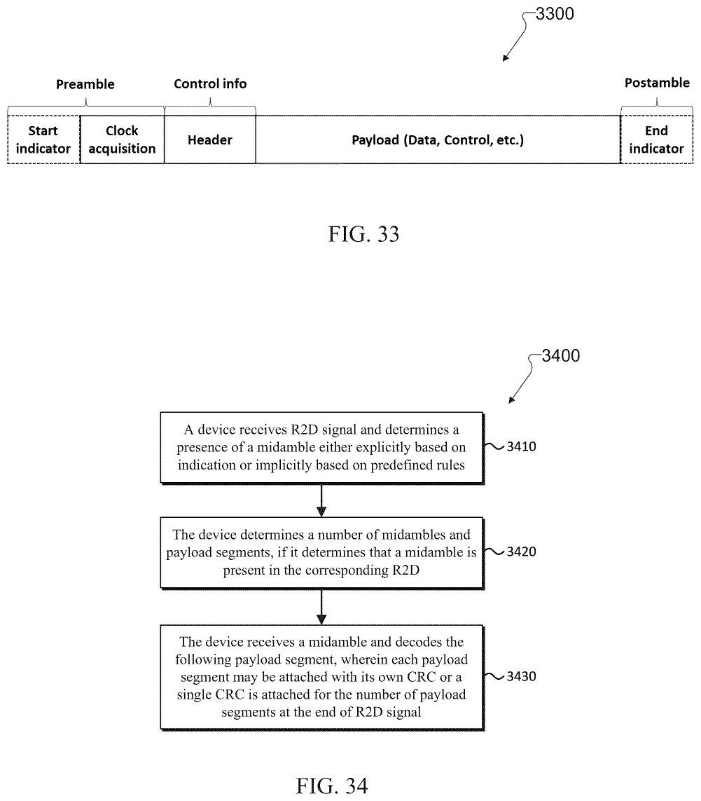

FIG. 33 illustrates a diagram of an example PRDCH/PDRCH signal structure 3300 according to embodiments of the present disclosure. For example, PRDCH/PDRCH signal structure 3300 can be transmitted/received to/from a reader and the IoT devices described herein.

This example is for illustration only and other embodiments can be used without departing from the scope of the present disclosure.

FIG. 31 illustrates an example flowchart of an A-IoT device to receive R2D preamble according to the disclosure.

FIG. 32 illustrates an example flowchart of an A-IoT device to generate D2R preamble according to the disclosure.

FIG. 33 illustrates an example PRDCH/PDRCH structure according to the disclosure.

For R2D, the preamble includes a start-indicator part and a clock-acquisition part, there is no gap, as illustrated in FIG. 33. In one example, the start-indicator, i.e., delimiter, can be a fixed length low voltage signal. The start-indicator field may be also utilized for the purpose of wake-up signal (WUS) for devices to stay in a sleep mode until the start-indicator field is detected. Therefore, in another example, the start-indicator field may not be a simple fixed length low voltage signal, but it can be a short sequence that can facilitate the detection of the signal for the purpose of WUS. As an example, it can be a certain high/low-voltage pattern of a signal for a certain duration. In another example, it is encoded with a number of bits, e.g., 00, 01, 10, or 11. In another example, the start-indicator part is an encoded signal of 10101011.

For D2R, the preamble may not include a start-indicator part as the D2R transmission is triggered by a reader and, thus, the start timing of D2R transmissions is known by the reader. In another example, the D2R preamble also include a start-indicator part, wherein the design of the start-indicator part can be similar to that of R2D preamble.

The clock acquisition part can be a sequence transmitted in time domain providing timing synchronization for the demodulation of the following fields, such as header and payload. It may be also used for channel estimation and setting up the AGC, etc. The design of clock acquisition part will be dependent on the used encoding schemes. For instance, in the case of PIE encoding, the clock acquisition part needs to provide a calibration for signal pulse durations for bit 0 and 1, as bit 1 has different pulse duration than bit 0. In the case of Manchester encoding, the clock acquisition part can be comprised of a sufficient number of alternations between 0 and 1 for providing a synchronization, while the signal for bit 0 and 1 has a fixed length. In one example, the clock-acquisition part is an encoded signal of 10101010.

For R2D, since the preamble is the first signal received by a device without a prior knowledge, in one example, the preamble signal structure is fixed, which does not require a blind detection at a device side.

Similarly, for D2R, the design of clock acquisition part will be dependent on the used encoding schemes, i.e., Manchester, FM0, and Miller encoding schemes. Since D2R transmissions are triggered by a reader, the reader may indicate a format of the clock acquisition part to a device, e.g., long and short formats, used for the subsequent D2R transmissions in the preceding R2D control information. The use of different formats, e.g., long and short formats, may be predefined in the specifications based on a certain condition, e.g., packet length, D2R transmission duration or type, etc. As an example, if the payload size is greater than a certain predefined threshold, the device attaches a long preamble format. Otherwise, the device attaches a short preamble format. In another example, if the D2R message type falls into one of a predefined set of message types, the device attaches a long preamble. Otherwise, the device attaches a long preamble format. In one example, the preamble format indication in the R2D control information overrides the predefined rule for applying long or short preamble. In another example, the device follows the predefined rule regardless of the indication. That is, if a certain condition is met, a device use a predefined format regardless of the presence or the value of the indication.

When PIE encoding is used, in one example, the clock-acquisition part is comprised of 01, followed by a pulse providing device to reader calibration for D2R transmission, wherein the D2R calibration signal may or may not be present. As an example, a device can assume that the D2R calibration is present in a preamble for a certain set of PRDCH message types, while the D2R calibration is not present in a preamble for some other PRDCH message types.

When FM0 encoding is used, the clock-acquisition part is comprised a number of alternations of 1 and 0, followed by v1, wherein v is a low-voltage state for a given chip duration. In one example, the clock-acquisition part is 1010v1, i.e., short format. In another example, 1010v1 is preceded by a number of zeros, i.e., long format. For D2R preamble, a type of preamble is indicated in the preceding R2D control information or determined by the device based on a predefined condition as disclosed earlier.

When Miller encoding is used, in one example, the clock-acquisition part starts with a number of zeros followed by a sequence of 0 and 1. In one example, the clock-acquisition part starts with a first number of zeros followed by 010111, i.e., a short format. In another example, the clock-acquisition part starts with a second number of zeros followed by 010111, i.e., a long format. For D2R preamble, a type of preamble is indicated in the preceding R2D control information or determined by the device based on a predefined condition as disclosed earlier.

A device monitors a start-indicator part of a preamble from a reader continuously or intermittently. In one example, the device monitors a preamble continuously as long as the device has energy to operate. When the device is running out of energy, the device goes into energy harvesting and charging mode and the device resumes monitoring when it is sufficiently recharged, e.g., the stored energy level exceeds a certain threshold. In another example, the device monitors a preamble with a certain time pattern with on-duration and off-duration. The periodicity and on/off-duration for monitoring a preamble may be based on device-specific charging time and discharging time, which maybe pre-programmed during implementation or calculated during the operation. The periodicity and on/off-duration, and offset that determines the timing for monitoring a preamble may be assumed only by the device itself. In another example, a reader may request a device to report the duty cycle related parameters, as disclosed herein, and the device may reply accordingly. In yet another example, a device reports to the reader the duty cycle related parameters, when it first communicates with the reader, periodically, or aperiodically when parameters are updated.

FIG. 34 illustrates a flowchart of an example procedure 3400 for receiving a R2D preamble according to embodiments of the present disclosure. For example, procedure 3400 can be performed by an A-IoT device, such as IoT devices 900, 950, 1100, 1150, 1200, 1250, 2300, 2400, 2500, 2600, 2700, 2800, or 2900. This example is for illustration only and other embodiments can be used without departing from the scope of the present disclosure.

The procedure begins in 3410, a device receives R2D signal and determines a presence of a midamble either explicitly based on indication or implicitly based on predefined rules. In 3420, the device determines a number of midambles and payload segments, if it determines that a midamble is present in the corresponding R2D. In 3430, the device receives a midamble and decodes the following payload segment, wherein each payload segment may be attached with its own CRC, or a single CRC is attached for the number of payload segments at the end of R2D signal.

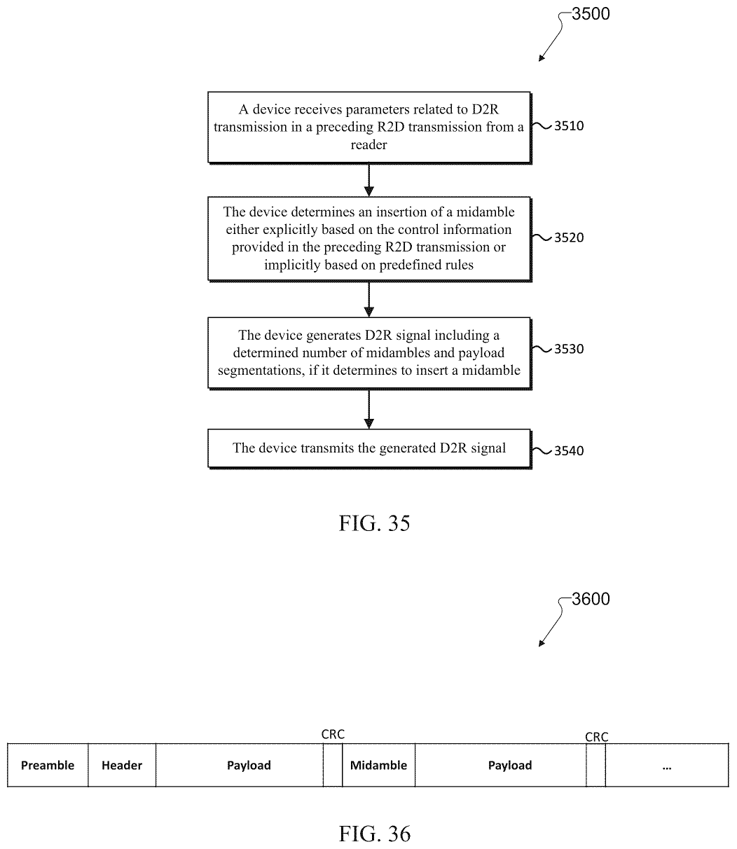

FIG. 35 illustrates a flowchart of an example procedure 3500 for generating a D2R preamble according to embodiments of the present disclosure. For example, procedure 3500 can be performed by the IoT devices described herein. This example is for illustration only and other embodiments can be used without departing from the scope of the present disclosure.

The procedure begins in 3510, a device receives parameters related to D2R transmission in a preceding R2D transmission from a reader. In 3520, the device determines an insertion of a midamble either explicitly based on the control information provided in the preceding R2D transmission or implicitly based on predefined rules. In 3530, the device generates D2R signal including a determined number of midambles and payload segmentations, if it determines to insert a midamble. In 3540, the device transmits the generated D2R signal.

FIG. 36 illustrates a diagram of an example PRDCH/PDRCH signal structure 3600 according to embodiments of the present disclosure. For example, PRDCH/PDRCH signal structure 3600 can be transmitted/received to/from a reader and the IoT devices described herein. This example is for illustration only and other embodiments can be used without departing from the scope of the present disclosure.

FIG. 34 illustrates an example flowchart of an A-IoT device to receive R2D preamble according to the disclosure.

FIG. 35 illustrates an example flowchart of an A-IoT device to generate D2R preamble according to the disclosure.

For D2R transmission, an insertion of a midamble may be explicitly indicated by a reader in the preceding R2D transmission, e.g., PRDCH providing control information. In one example, it can be a simple on/off indication, and the device performs payload segmentation assuming a predefined payload size per segment if indicated that midamble is turned on. In another example, the R2D control information may provide a number of midambles, a number of payload segmentations, and/or payload size per segment.

The insertion of a midamble may be also implicit as described for PRDCH, i.e., based on the PDRCH message type and/or the PDRCH payload size.

FIG. 36 illustrates an example PRDCH/PDRCH signal structure with midamble according to the disclosure.

For R2D transmission, the presence of a midamble may be either explicitly or implicitly known by a target device. As an example of an explicit indication, the header field of PRDCH may provide an indication regarding midamble, such as a number of payload segmentations and the size of each payload, which may be identical. Each payload segments, other than the first payload segment, is immediately preceded by a midamble. The first payload segment is not accompanied by a midamble as it follows the preamble. An implicit indication may be based on the PRDCH message type and/or the payload size indicated in the header of the PRDCH.

For instance, if the PRDCH message type falls into one of a predefined set of message types, or the indicated payload size is greater than a certain predefined threshold, the device expects payload segmentation based on a predefined payload segment size, and a number of midambles correspondingly.

For D2R transmission, an insertion of a midamble may be explicitly indicated by a reader in the preceding R2D transmission, e.g., PRDCH providing control information. In one example, it can be a simple on/off indication, and the device performs payload segmentation assuming a predefined payload size per segment if indicated that midamble is turned on. In another example, the R2D control information may provide a number of midambles, a number of payload segmentations, and/or payload size per segment.

The insertion of a midamble may be also implicit as described for PRDCH, i.e., based on the PDRCH message type and/or the PDRCH payload size.

For both R2D and D2R transmissions, the control field, i.e., header, may be attached with a separate CRC, e.g., CRC-6.

For both R2D and D2R transmissions, each of the payload segment can be attached with a separate CRC, which helps to decode payloads sequentially without waiting for the end of the signal reception and requires less memory buffer size at the receiver.

FIG. 33 illustrates a basic PRDCH/PDRCH structure, including postamble. Postamble may be beneficial to facilitate the end-of-signalling (EOS) detection, regardless of whether the packet length is known based on an indication in the header or for certain message types with fixed length, since the clock synchronization may not be perfectly maintained until the end of signal reception. On the other hand, further clock synchronization obtained from the postamble may or may not be utilized for clock refinement depending on the receiver implementation. Especially, it's unlikely to be utilized at a device side as the synchronization obtained from the postamble requires additional signal processing such as interpolation and the decoding needs to wait until the end of signal reception. Therefore, the postamble can be designed to support only the EOS indication as an end delimiter with a short sequence.

In one example, for R2D transmission, a device expects that a postamble is attached, if the indicated payload size is greater than a certain predefined threshold, if the R2D message type falls into one of a predefined set of types, or if the attachment of postamble is explicitly indicated in the R2D control information. Otherwise, the device assume that a corresponding R2D transmission is not attached with a postamble.

In another example, for D2R transmission, a device expects to attach a postamble in its D2R transmission, if the indicated payload size for D2R transmission in the preceding R2D control information is greater than a certain predefined threshold, if the D2R message type falls into one of a predefined set of types, or if the attachment of postamble is explicitly indicated in the R2D control information. Otherwise, the device assume to not to attach a postamble to the corresponding D2R transmission.

In one example, for line coding schemes, e.g., Manchester, PIE, FM0, and Miller encoding, the postamble is a waveform generated from sequence 01, 00, 10, or 11.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for an Internet of Things (IoT) device to communicate with a reader, the method comprising:
receiving a first signal indicating a start of reader-to-device (R2D) reception;
receiving a second signal providing synchronization for the reception of a physical reader-to-device channel (PRDCH), wherein:
the first signal and the second signal are patterns including ON/OFF states in time domain,
the first signal has a fixed duration in time, and
the second signal follows the first signal;
receiving the PRDCH, wherein:
the PRDCH includes at least one of (i) control information related to R2D reception or device-to-reader (D2R) transmission and (ii) a payload providing R2D data, and
the control information is provided via layer one (L1) signaling in a separate field or via higher layer signaling as R2D data in the payload;
determining, based on the reception of the PRDCH, parameters related to D2R transmission including a size of a payload providing D2R data;
transmitting a third signal providing synchronization for the reception of a physical device-to-reader channel (PDRCH); and
transmitting the PDRCH, wherein:
the PDRCH includes the payload providing D2R data, and
the PDRCH follows the third signal.

2. The method of claim 1, wherein:
determining the parameters related to D2R transmission further include inserting a fourth signal within the PDRCH,
the fourth signal provides additional synchronization for reception of the PDRCH,
the inserting of the fourth signal is (i) indicated in the control information of the PRDCH or (ii) determined based on a predefined rule related to the size of the payload providing D2R data or a transmission duration of the PDRCH, and
transmitting the PDRCH further comprises transmitting the PDRCH with the fourth signal inserted within the PDRCH.

3. The method of claim 1, wherein:
determining the parameters related to D2R transmission further includes segmenting the payload providing D2R data,
the parameters related to D2R transmission include a number of payload segments, and
transmitting the PDRCH further comprises transmitting the PDRCH in more than one transmission for transmitting the number of payload segments.

4. The method of claim 1, wherein the control information related to D2R transmission provides parameters related to D2R transmission including at least one of:
a signal type,
a target device identifier, and
information related to the size of the payload providing D2R data.

5. The method of claim 1, wherein:
the PRDCH includes a cyclic redundancy check (CRC) with (i) a first number of CRC bits when the size of the payload providing R2D data is less than a first threshold and (ii) a second number of CRC bits when the size of the payload providing R2D data is greater than or equal to the first threshold,
the PDRCH includes a CRC with (i) a third number of CRC bits when the size of the payload providing D2R data is less than a second threshold and (ii) a fourth number of CRC bits when the size of the payload providing D2R data is greater than or equal to the second threshold,
the first number and the third number are positive integers or zero,
the second number and the fourth number are positive integers and greater than the first number and the third number, respectively, and
the first threshold and the second threshold are positive integers.

6. The method of claim 1, wherein:
the PDRCH is encoded with a convolutional code, and
encoding parameters are (i) fixed, (ii) indicated in the control information related to D2R transmission in the PRDCH, or (iii) determined based on a predefined rule related to the size of the payload providing D2R data.

7. The method of claim 1, wherein:
the PRDCH is appended with a fourth signal indicating an end of PRDCH reception and a presence of the fourth signal is (i) mandatory, (ii) indicated in the control information related to R2D reception, or (iii) determined based on a predefined rule related to the size of the payload providing R2D data or a transmission duration of the PRDCH, or
the PDRCH is prepended with a fifth signal indicating an end of PDRCH transmission and attachment of the fifth signal is (i) mandatory, (ii) indicated in the control information related to D2R transmission in the PRDCH, or (iii) determined based on a predefined rule related to the size of the payload providing D2R data or a transmission duration of the PDRCH.

8. An Internet of Things (IoT) device, comprising:
a transceiver configured to:
receive a first signal indicating a start of reader-to-device (R2D) reception;
receive a second signal providing synchronization for the reception of a physical reader-to-device channel (PRDCH), wherein:
the first signal and the second signal are patterns including ON/OFF states in time domain,
the first signal has a fixed duration in time, and
the second signal follows the first signal; and
receive the PRDCH, wherein:
the PRDCH includes at least one of (i) control information related to R2D reception or device-to-reader (D2R) transmission and (ii) a payload providing R2D data, and
the control information is provided via layer one (L1) signaling in a separate field or via higher layer signaling as R2D data in the payload; and
processing circuitry operably coupled with the transceiver, the processing circuitry configured to determine, based on the reception of the PRDCH, parameters related to D2R transmission including a size of a payload providing D2R data,
wherein the transceiver is further configured to:
transmit a third signal providing synchronization for the reception of a physical device-to-reader channel (PDRCH); and
transmit the PDRCH, wherein:
the PDRCH includes the payload providing D2R data, and
the PDRCH follows the third signal.

9. The IoT device of claim 8, wherein:
the processing circuitry is further configured to insert a fourth signal within the PDRCH,
the fourth signal provides additional synchronization for reception of the PDRCH,
the inserting of the fourth signal is (i) indicated in the control information of the PRDCH or (ii) determined based on a predefined rule related to the size of the payload providing D2R data or a transmission duration of the PDRCH, and
the transceiver is further configured to transmit the PDRCH with the fourth signal inserted within the PDRCH.

10. The IoT device of claim 8, wherein:
the processing circuitry is further configured to segment the payload providing D2R data,
the parameters related to D2R transmission include a number of payload segments, and
the transceiver is further configured to transmit the PDRCH in more than one transmission for transmitting the number of payload segments.

11. The IoT device of claim 8, wherein the control information related to D2R transmission provides parameters related to D2R transmission including at least one of:
a signal type,
a target device identifier, and
information related to the size of the payload providing D2R data.

12. The IoT device of claim 8, wherein:
the PRDCH includes a cyclic redundancy check (CRC) with (i) a first number of CRC bits when the size the payload providing R2D data is less than a first threshold and (ii) a second number of CRC bits when the size of the payload providing R2D data is greater than or equal to the first threshold,
the PDRCH includes a CRC with (i) a third number of CRC bits when the size of the payload providing D2R data is less than a second threshold and (ii) a fourth number of CRC bits when the size of the payload providing D2R data is greater than or equal to the second threshold,
the first number and the third number are positive integers or zero,
the second number and the fourth number are positive integers and greater than the first number and the third number, respectively, and
the first threshold and the second threshold are positive integers.

13. The IoT device of claim 8, wherein:
the PDRCH is encoded with a convolutional code, and
encoding parameters are (i) fixed, (ii) indicated in the control information related to D2R transmission in the PRDCH, or (iii) determined based on a predefined rule related to the size of the payload providing D2R data.

14. The IoT device of claim 8, wherein:
the PRDCH is appended with a fourth signal indicating an end of PRDCH reception and a presence of the fourth signal is (i) mandatory, (ii) indicated in the control information related to R2D reception, or (iii) determined based on a predefined rule related to the size of the payload providing R2D data or a transmission duration of the PRDCH, or
the PDRCH is prepended with a fifth signal indicating an end of PDRCH transmission and attachment of the fifth signal is (i) mandatory, (ii) indicated in the control information related to D2R transmission in the PRDCH, or (iii) determined based on a predefined rule related to the size of the payload providing D2R data or a transmission duration of the PDRCH.

15. A reader, comprising:
a transceiver configured to:
transmit a first signal indicating a start of reader-to-device (R2D) transmission;
transmit a second signal providing synchronization for the transmission of a physical reader-to-device channel (PRDCH), wherein:
the first signal and the second signal are patterns including ON/OFF states in time domain,
the first signal has a fixed duration in time, and
the second signal follows the first signal; and
transmit the PRDCH, wherein:
the PRDCH includes at least one of (i) control information related to R2D reception or device-to-reader (D2R) reception and (ii) a payload providing R2D data, and
the control information is provided via layer one (L1) signaling in a separate field or via higher layer signaling as R2D data in the payload; and
a processor operably coupled with the transceiver, the processor configured to determine, based on the PRDCH, parameters related to D2R reception including a size of a payload providing D2R data,
wherein the transceiver is further configured to:
receive a third signal providing synchronization for the reception of a physical device-to-reader channel (PDRCH); and
receive the PDRCH, wherein:
the PDRCH includes the payload providing D2R data, and
the PDRCH follows the third signal.

16. The reader of claim 15, wherein:
a fourth signal is inserted within the PDRCH,
the fourth signal provides additional synchronization for reception of the PDRCH,
the insertion of the fourth signal is (i) indicated in the control information of the PRDCH or (ii) based on a predefined rule related to the size of the payload providing D2R data or a reception duration of the PDRCH, and
the transceiver is further configured to receive the PDRCH with the fourth signal inserted within the PDRCH.

17. The reader of claim 15, wherein:
the payload providing D2R data is segmented,
the parameters related to D2R reception include a number of payload segments, and
the transceiver is further configured to receive the PDRCH in more than one reception for receiving the number of payload segments.

18. The reader of claim 15, wherein the control information related to D2R reception provides parameters related to D2R reception including at least one of:
a signal type,
a target device identifier, and
information related to the size of the payload providing D2R data.

19. The reader of claim 15, wherein:
the PRDCH includes a cyclic redundancy check (CRC) with (i) a first number of CRC bits when the size the payload providing R2D data is less than a first threshold and (ii) a second number of CRC bits when the size of the payload providing R2D data is greater than or equal to the first threshold,
the PDRCH includes a CRC with (i) a third number of CRC bits when the size of the payload providing D2R data is less than a second threshold and (ii) a fourth number of CRC bits when the size of the payload providing D2R data is greater than or equal to the second threshold,
the first number and the third number are positive integers or zero,
the second number and the fourth number are positive integers and greater than the first number and the third number, respectively, and
the first threshold and the second threshold are positive integers.

20. The reader of claim 15, wherein:
the PDRCH is encoded with a convolutional code, and
encoding parameters are (i) fixed, (ii) indicated in the control information related to D2R transmission in the PRDCH, or (iii) determined based on a predefined rule related to the size of the payload providing D2R data.
